(19) United States
(12) Patent Application Publication
(10) Pub. No.: US 2021/0216559 A1
(43) Pub. Date: Jul. 15, 2021

(54) METHODS AND SYSTEMS FOR FINDING VARIOUS TYPES OF EVIDENCE OF PERFORMANCE PROBLEMS IN A DATA CENTER

(71) Applicant: VMware, Inc., Palo Alto, CA (US)

(72) Inventors: Karen Aghajanyan, Yerevan (AM); Hovhannes Antonyan, Yerevan (AM); Naira Movses Grigoryan, Yerevan (AM); Arnak Poghosyan, Yerevan (AM); Ashot Nshan Harutyunyan, Yerevan (AM); Sunny Dua, Palo Alto, CA (US); Bonnie Zhang, Palo Alto, CA (US)

(73) Assignee: VMware, Inc., Palo Alto, CA (US)

(21) Appl. No.: 16/742,120

(22) Filed: Jan. 14, 2020

(51) Int. Cl. G06F 16/2457; G06F 16/25; G06F 3/0484

(52) U.S. Cl. CPC G06F 16/24578; G06F 3/04847; G06F 16/252

(57) ABSTRACT

Methods and systems are directed to finding various types of evidence of performance problems with objects in a data center, troubleshooting the performance problems, and generating recommendations for correcting the performance problems. A performance problem with an object of a data center, such as a server computer, an application, or a virtual machine (“VM”), may result from performance problems associated with other objects of the data center. The methods and systems detect origins of performance problems with objects for which no alerts and parameters for detecting the performance problems have been defined or detect performance problems related to alerts that fail to point to a root cause of the performance problem.

### TECHNICAL FIELD

This disclosure is directed to data centers and troubleshooting performance problems in data centers.

### BACKGROUND

Electronic computing has evolved from primitive, vacuum-tube-based computer systems, initially developed during the 1940s, to modern electronic computing systems in which large numbers of multi-processor computer systems, such as server computers, work stations, and other individual computing systems are networked together with large-capacity data-storage devices and other electronic devices to produce geographically distributed computing systems with hundreds of thousands of components that provide enormous computational bandwidths and data-storage capacities. These large, distributed computing systems are typically housed in data centers and made possible by advances in computer networking, distributed operating systems and applications, data-storage appliances, computer hardware, and software technologies.

In recent years, data centers have grown to meet the increasing demand for information technology (“IT”) services, such as running applications for organizations that provide business and web services to millions of customers. In order to proactively manage IT systems and services, management tools have been developed to collect various forms of information, such as metrics and log messages, to aid system administrators and application owners in detection of performance problems. However, typical management tools are not able to troubleshoot the causes of many types of performance problems from the information collected. As a result, system administrators and application owners manually troubleshoot performance problems which is time consuming, costly, and can lead to lost revenue. For example, a typical management tool generates an alert when the response time of a service to a request from a client exceeds a response time threshold. As a result, system administrators are made aware of the problem when the alert is generated. But system administrators may not be able to timely troubleshoot the cause of the delayed response time because the cause may be the result of performance problems occurring with hardware and software executing elsewhere in the data center. Moreover, alerts and parameters for detecting the performance problems may not be defined or many alerts fail to point to causes of the performance problems. System administrators and application owners seek methods and systems that can find and troubleshoot performance problems in a data center and provide recommendations for correcting the problems, giving system administrators and application owners an opportunity to timely implement the recommendations.

### SUMMARY

Methods and systems are directed to finding various types of evidence of performance problems with objects in a data center, troubleshooting the performance problems, and generating recommendations for correcting the performance problems. A performance problem with an object of a data center, such as a server computer, an application, or a virtual machine (“VM”), may result from performance problems associated with other objects of the data center. The methods and systems find performance problems with objects for which no alerts and parameters for detecting the performance problems have been defined or detect performance problems related to alerts that fail to point to a root cause of the performance problem. Methods identify objects of an object topology of the data center and find various types of evidence of changes that correspond to performance problems in behavior of the objects. A rank is computed for each of the various types of evidence. Recommendations that correct performance problems associated with the changes are generated based on the rank of each of the various types of evidence.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows example virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIGS. 14A-14B shows an operations manager that receives object information from various physical and virtual objects.

FIGS. 15A-15B show examples object topologies of objects of a data center.

FIG. 16 shows an overview of a method for finding various types of evidence of performance problems with objects of an object topology of a data center.

FIG. 17 shows a plot of an example metric.

FIG. 18 shows a plot of an example metric in which the mean value for metric values of the metric shifted.

FIG. 19A shows a plot of time-series metric data within a sliding time window.

FIG. 19B shows graphs and a statistic computed for metric values in the left-hand and right-hand windows of a sliding time window.

FIG. 20 shows an example of logging log messages in log files.

FIG. 21 shows an example source code of an event source that generates log messages.

FIG. 22 shows an example of a log write instruction.

FIG. 23 shows an example of a log message generated by the example log write instruction in FIG. 22.

FIG. 24 shows an example of eight log message entries of a log file.

FIG. 25 shows an example of event analysis performed on an example log message.

FIG. 26 shows a plot of examples of trends in error, warning, and informational log messages.

FIGS. 27A-27B show examples of log messages partitioned into two sets of log messages.

FIG. 28 shows event-type logs obtained from the two set of log messages in FIG. 27A.

FIG. 29 shows determination of a sentiment score and criticality score for a list of events recorded in the troubleshooting time period.

FIG. 30A show an example of a Boolean property metric associated with an object.

FIG. 30B show an example of a counter property metric associated with an object.

FIGS. 31A-31B show an example of constructing an application trace and spans.

FIGS. 32A-32B shows examples of erroneous traces associated with the services represented in FIG. 31A.

FIG. 33 shows an example of a graphical user interface that list the various types of evidence and enables a user to rate the various types of evidence.

FIG. 34 is a flow diagram illustrating an example implementation of a “method for finding various types of evidence of performance problems in a data center.”

FIG. 35 is a flow diagram illustrating an example implementation of the “search for various types of evidence of changes in behavior of the objects” procedure performed in FIG. 34.

FIG. 36 is a flow diagram illustrating an example implementation of the “search for evidence of change points in metrics of the objects” procedure performed in FIG. 35.

FIG. 37 is a flow diagram illustrating an example implementation of the “search for evidence of changes in log messages of the objects” procedure performed in FIG. 35.

FIG. 38 is a flow diagram illustrating an example implementation of the “search for evidence of adverse events associated with the objects” procedure performed in FIG. 35.

FIG. 39 is a flow diagram illustrating an example implementation of the “search for evidence of property changes of the objects” procedure performed in FIG. 35.

FIG. 40 is a flow diagram illustrating an example implementation of the “search for evidence of changes in traces associated with the objects” procedure performed in FIG. 35.

FIG. 41 is a flow diagram illustrating an example implementation of the “compute rank for each of the various types of evidence” procedure performed in FIG. 34.

### DETAILED DESCRIPTION

This disclosure presents automated methods and systems for using log files to identify root causes of problems in a distributed computing system. In a first subsection, computer hardware, complex computational systems, and virtualization are described. Methods and systems for finding various types of evidence of performance problems in a data center are described below in a second subsection.

### Computer Hardware, Complex Computational Systems, and Virtualization

The term “abstraction” as used to describe virtualization below is not intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

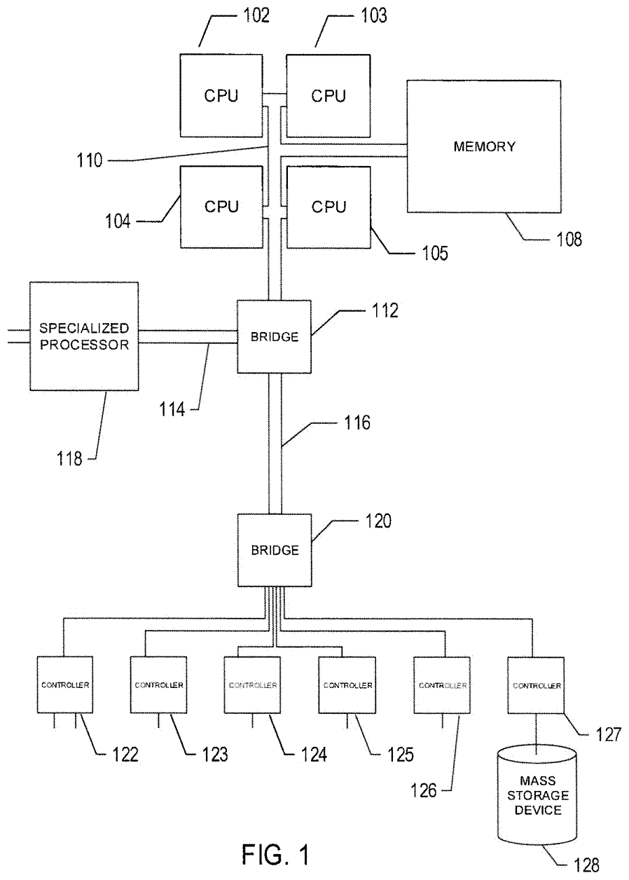

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

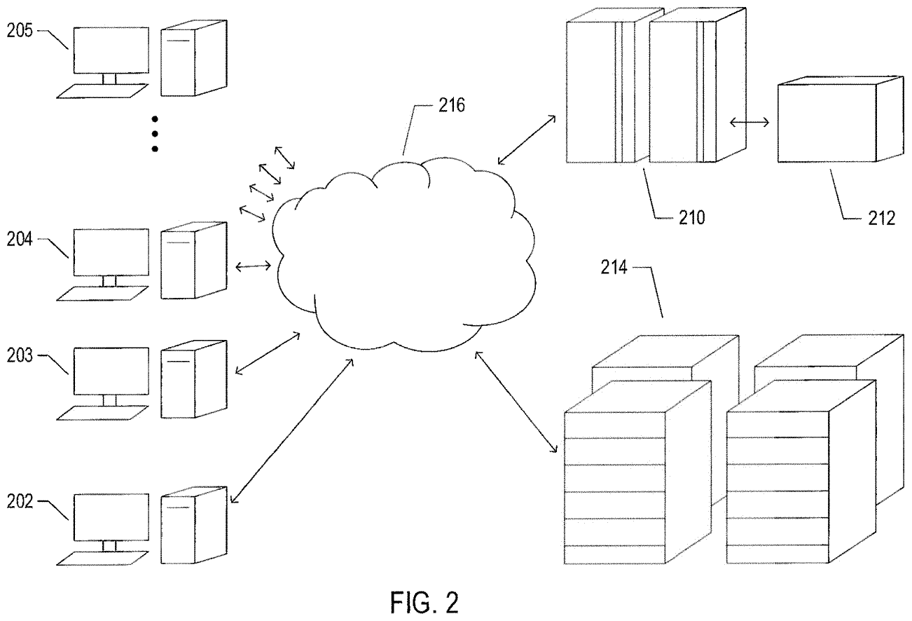

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

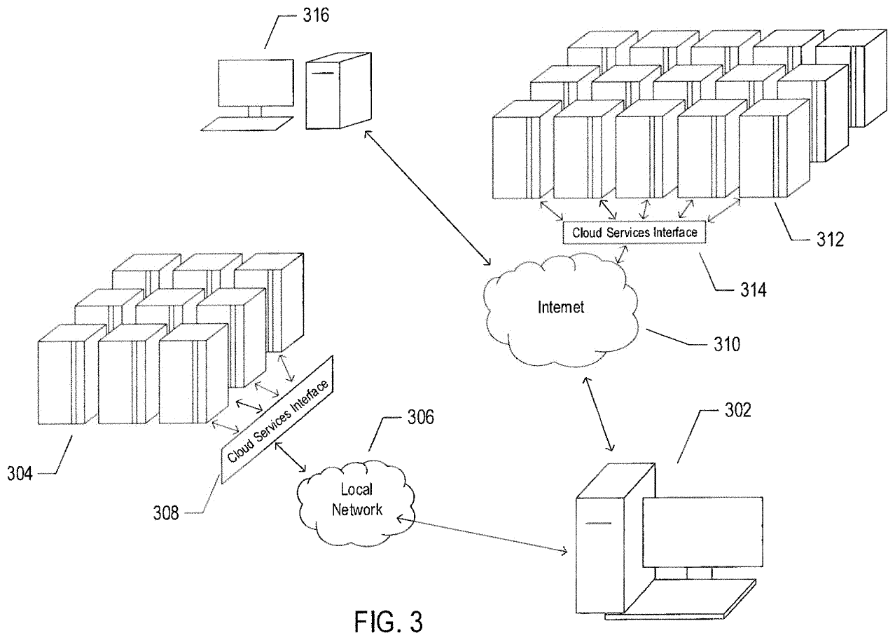

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

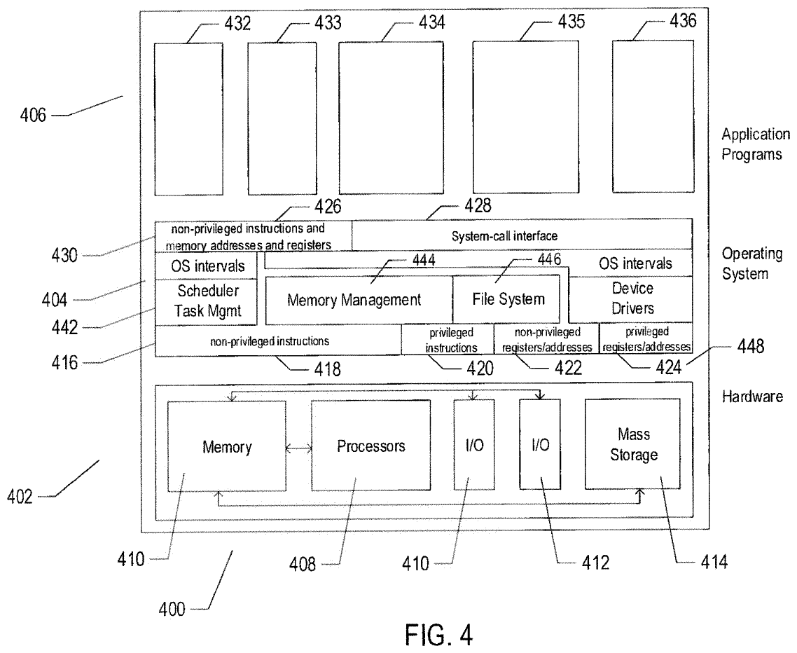

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

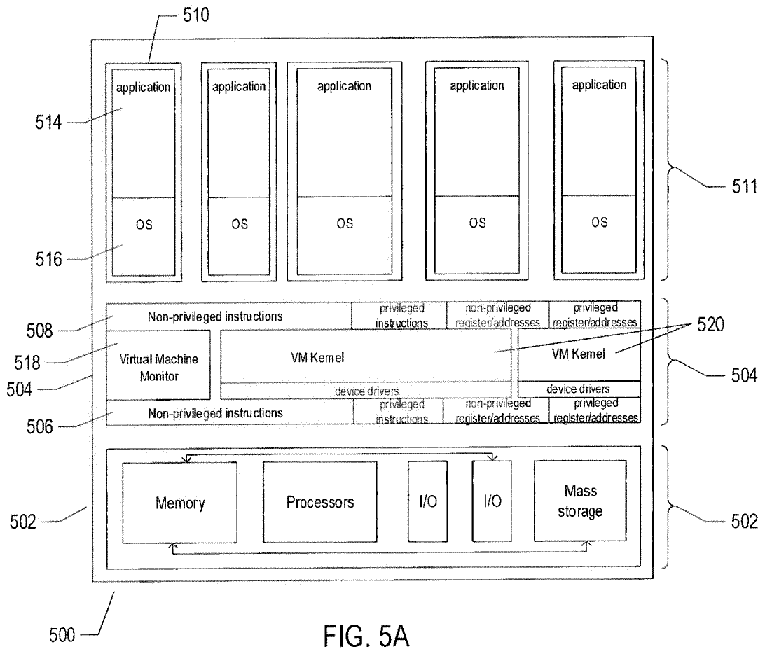

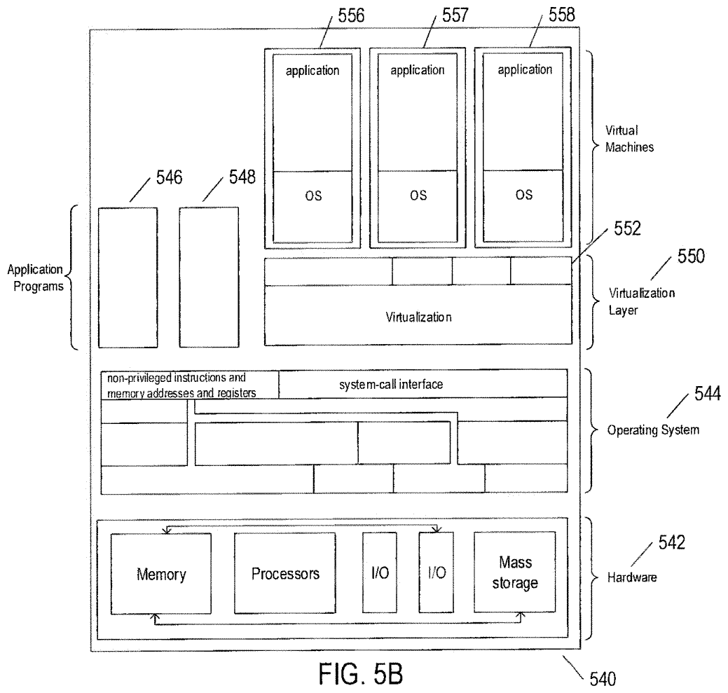

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

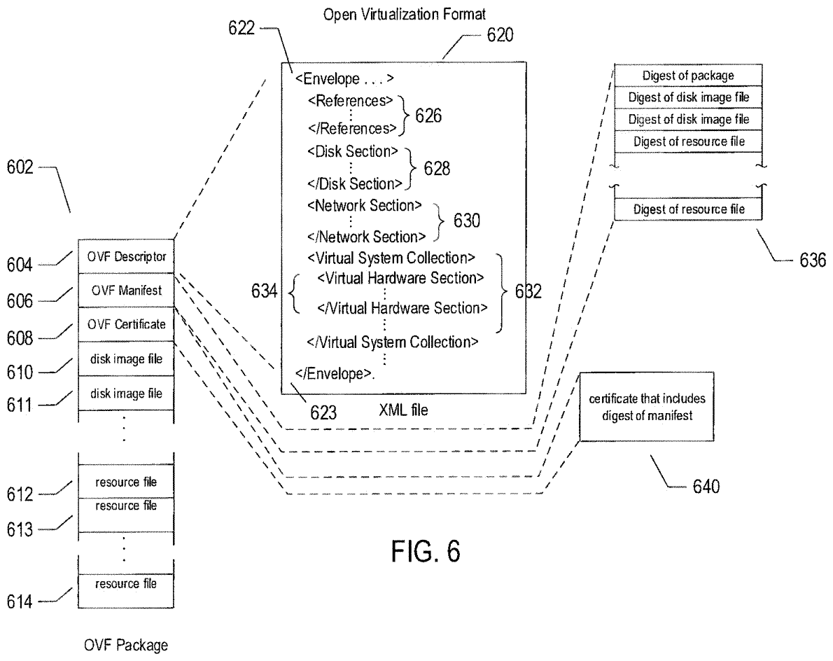

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

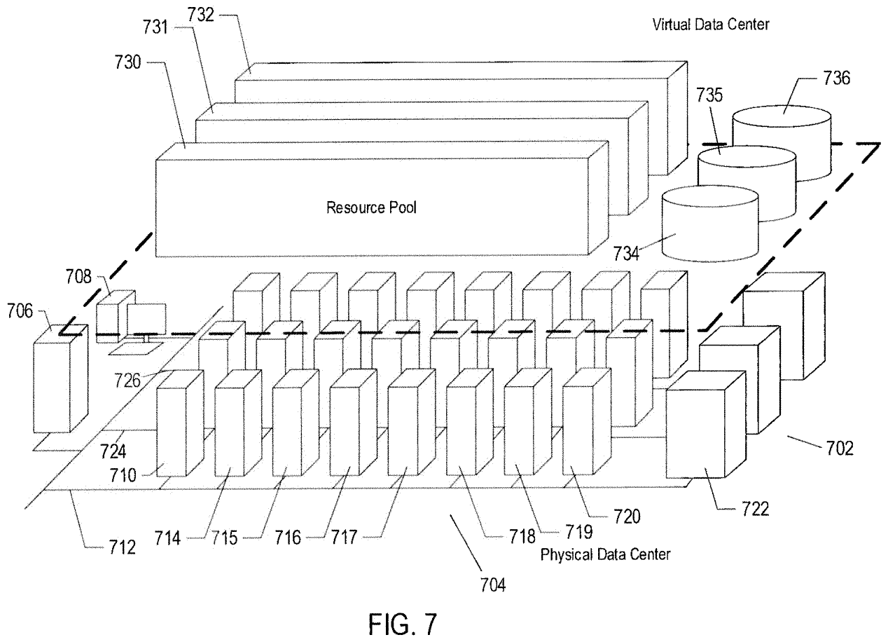

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

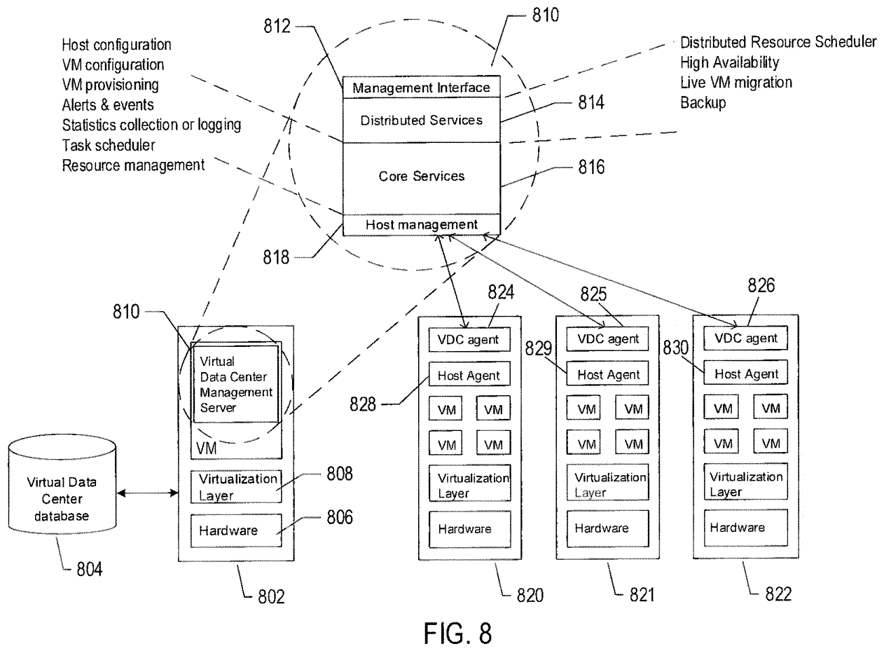

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

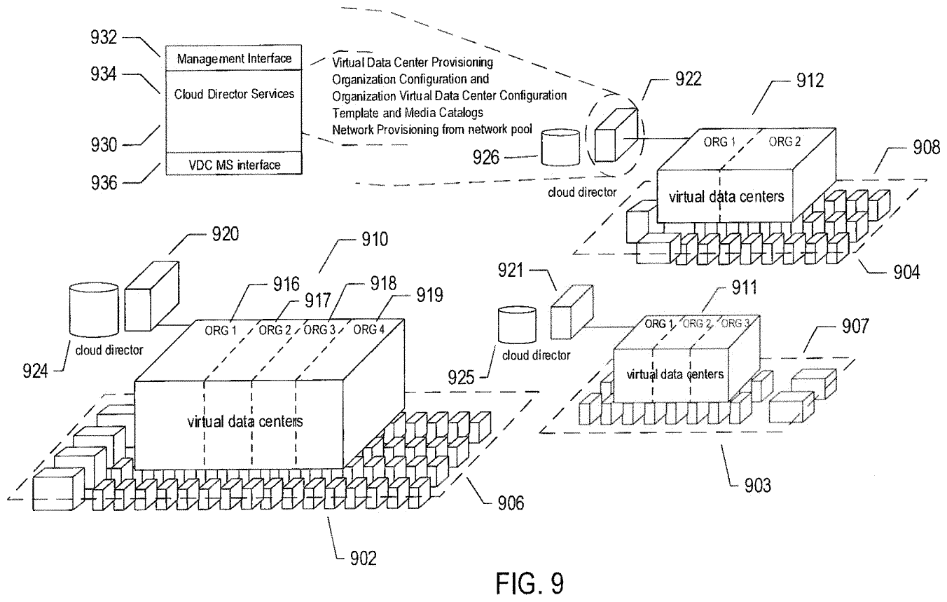

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

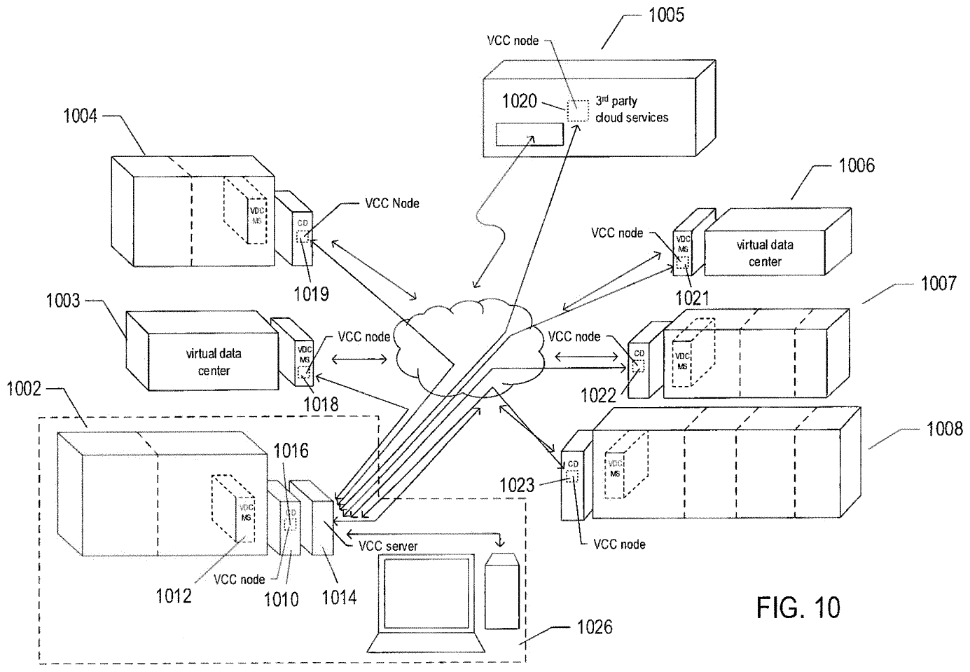

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

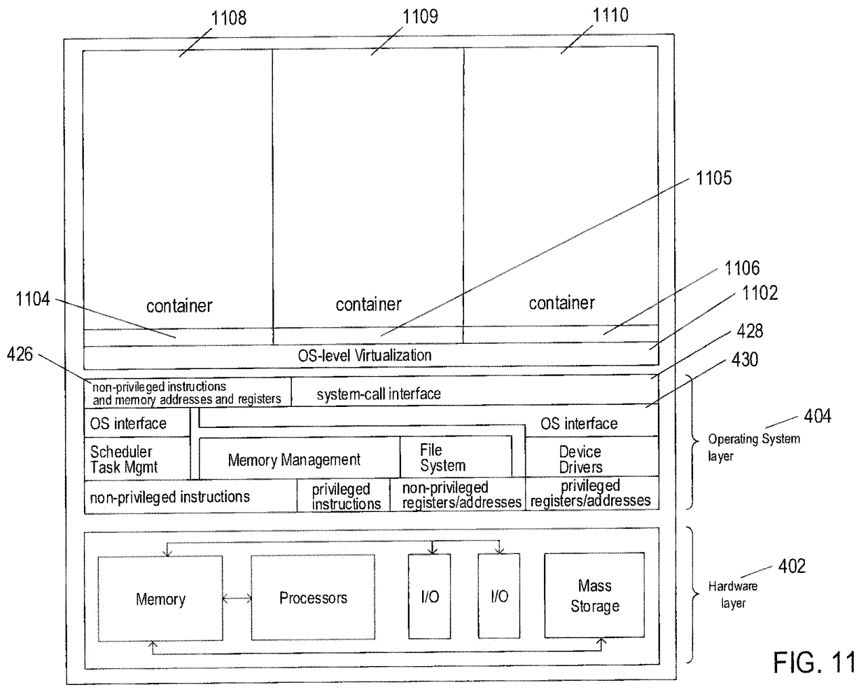

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

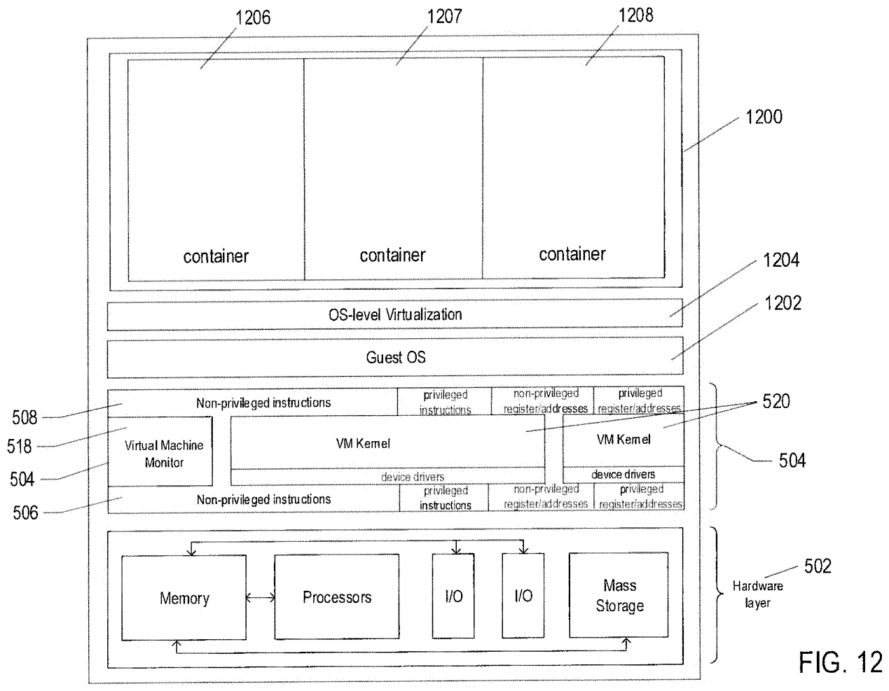

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Methods and Systems for Finding Various Types of Evidence of Performance Problems in a Data Center

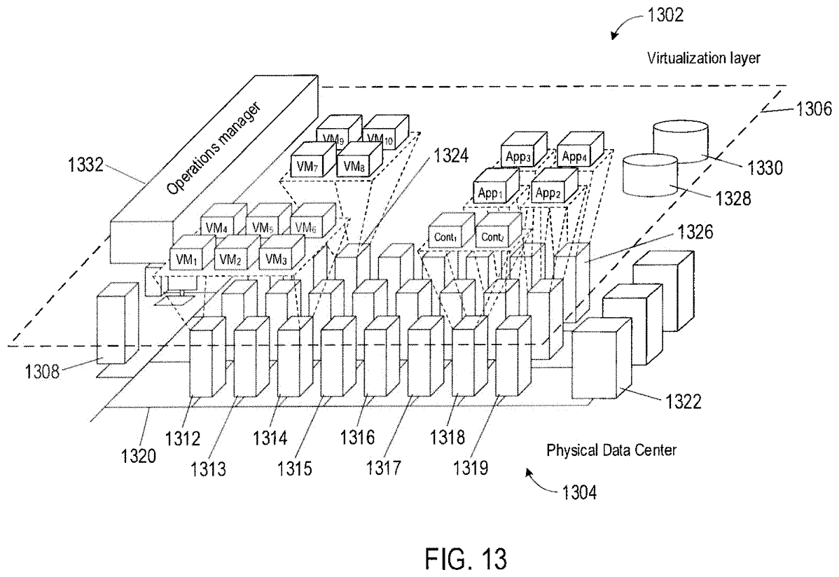

FIG. 13 shows an example of a virtualization layer 1302 located above a physical data center 1304. For the sake of illustration, the virtualization layer 1302 is separated from the physical data center 1304 by a virtual-interface plane 1306. The physical data center 1304 is an example of a distributed computing system. The physical data center 1304 comprises physical objects, including an administration computer system 1308, any of various computers, such as PC 1310, on which a virtual-data-center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers may be networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects in the virtualization layer 1302. Different physical data centers may include many different types of computers, networks, data-storage systems and devices connected according to many different types of connection topologies.

The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and NICs formed from the physical switches, routers, and NICs of the physical data center 1304. Certain server computers host VMs and containers as described above. For example, server computer 1318 hosts two containers identified as Cont₁ and Cont₂; cluster of server computers 1312-1314 host six VMs identified as VM₁, VM₂, VM₃, VM₄, VM₅, and VM₆; server computer 1324 hosts four VMs identified as VM₇, VM₈, VM₉, VM₁₀. Other server computers may host applications as described above with reference to FIG. 4. For example, server computer 1326 hosts an application identified as App₄.

The virtual-interface plane 1306 abstracts the resources of the physical data center 1304 to one or more VDCs comprising the virtual objects and one or more virtual data stores, such as virtual data stores 1328 and 1330. For example, one VDC may comprise the VMs running on server computer 1324 and virtual data store 1328. Automated methods and systems described herein may be executed by an operations manager 1332 in one or more VMs on the administration computer system 1308. The operations manager 1332 provides several interfaces, such as graphical user interfaces, for data center management, system administrators, and application owners. The operations manager 1332 receives streams of metric data from various physical and virtual objects of the data center as described below.

In the following discussion, the term “object” refers to a physical object, such as a server computer and a network device, or to a virtual object, such as an application, VM, virtual network device, or a container. The term “resource” refers to a physical resource of the data center, such as, but are not limited to, a processor, a core, memory, a network connection, network interface, data-storage device, a mass-storage device, a switch, a router, and other any other component of the physical data center 1304. Resources of a server computer and clusters of server computers may form a resource pool for creating virtual resources of a virtual infrastructure used to run virtual objects. The term “resource” may also refer to a virtual resource, which may have been formed from physical resources assigned to a virtual object. For example, a resource may be a virtual processor used by a virtual object formed from one or more cores of a multicore processor, virtual memory formed from a portion of physical memory and a hard drive, virtual storage formed from a sector or image of a hard disk drive, a virtual switch, and a virtual router. Each virtual object uses only the physical resources assigned to the virtual object.

The operations manager 1332 receives information regarding each object of the data center. The object information includes metrics, log messages, properties, events, application traces, and net flows. Methods implemented in the operations manager 1332 find various types of evidence of changes with objects that correspond to performance problems, troubleshoot the performance problems, and generate recommendations for correcting the performance problems. In particular, methods and systems detect performance problems with objects for which no alerts and parameters for detecting the performance problems have been defined or detect a performance problem related to alerts that fail to point to causes of the performance problems.

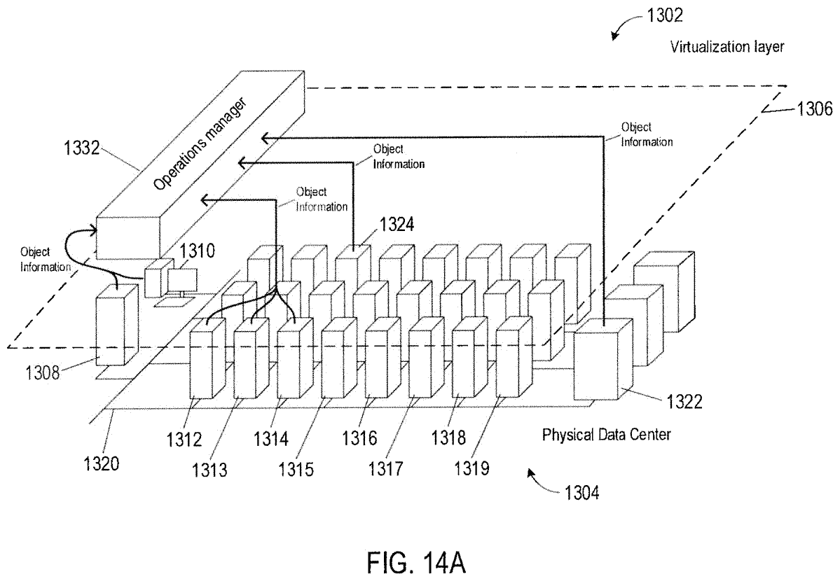

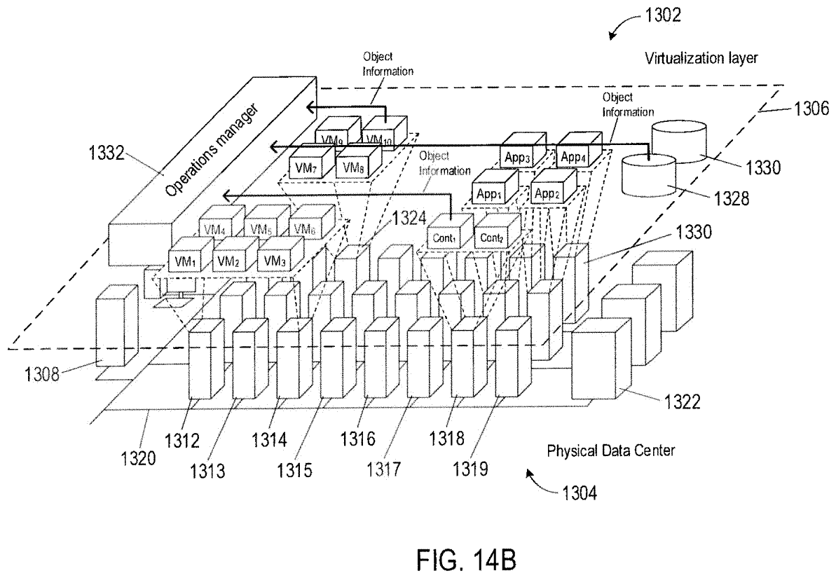

FIGS. 14A-14B show examples of the operations manager 1332 receiving object information from various physical and virtual objects. Directional arrows represent object information sent from physical and virtual resources to the operations manager 1332. In FIG. 14A, the operating systems of PC 1310, server computers 1308 and 1324, and mass-storage array 1322 send object information to the operations manager 1332. A cluster of server computers 1312-1314 send object information to the operations manager 1332. In FIG. 14B, the VMs, containers, applications, and virtual storage may independently send object information to the operations manager 1332. Certain objects may send metrics as the object information is generated while other objects may only send object information at certain times or when requested to send object information by the operations manager 1332. The operations manager 1332 may be implemented in a VM to collect and processes the object information as described below to detect performance problems and may generate recommendations to correct the performance problems or execute remedial measures, such as reconfiguring a virtual network of a VDC or migrating VMs from one server computer to another. For example, remedial measures may include, but are not limited to, powering down server computers, replacing VMs disabled by physical hardware problems and failures, spinning up cloned VMs on additional server computers to ensure that services provided by the VMs are accessible to increasing demand or when one of the VMs becomes compute or data-access bound.

Methods described below for finding various types of evidence of performance problems with objects in a data center, troubleshooting performance problems, and generating recommendations for correcting the performance problems may be applied to a set of data-center objects that are related by an object topology. An object topology of objects of a data center is determined by parent/child relationships between the objects comprising the set. For example, a server computer is a parent with respect VMs (i.e., children) executing on the host, and, at the same time, the server computer is a child with respect to a cluster (i.e., parent). The object topology may be represented as a graph of objects. The object topology for a set of objects may be dynamically created by the operations manager 1332 subject to continuous updates to VMs and server computers and other changes to the data center.

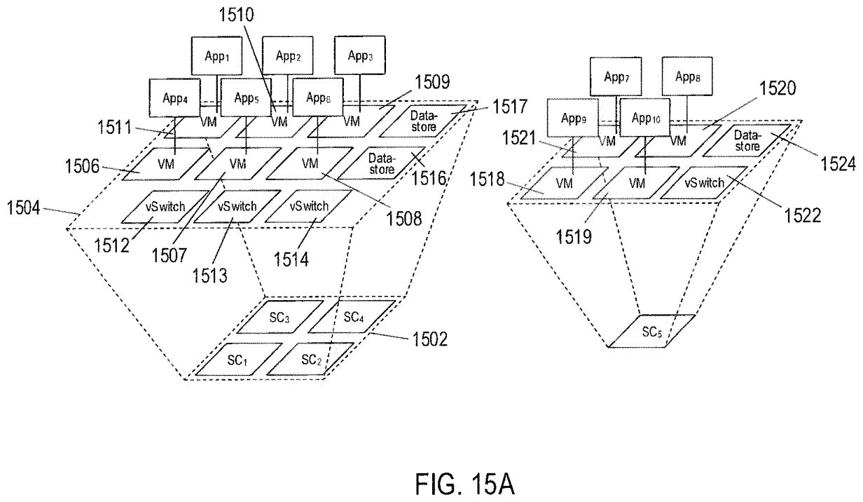

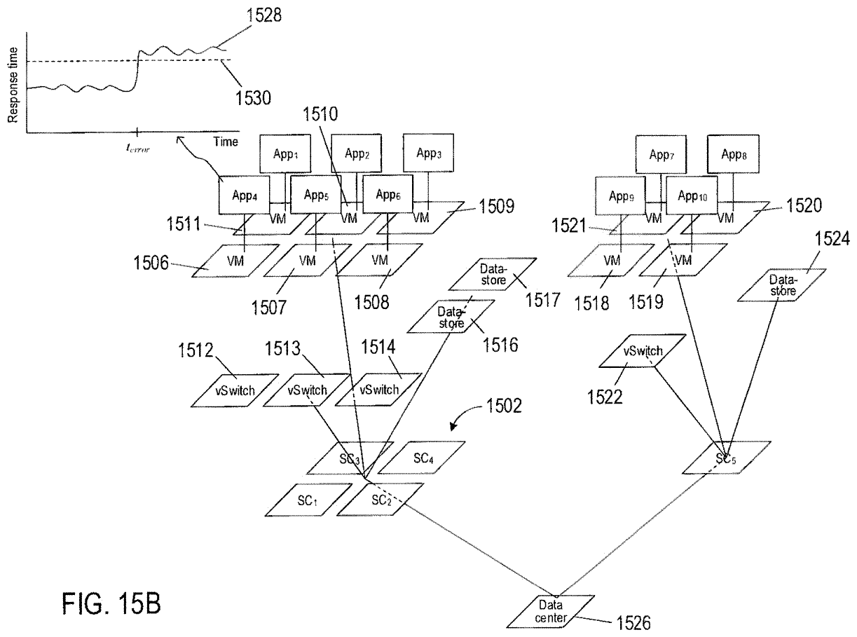

FIG. 15A shows a first example object topology for objects of a data center. In this example, a cluster 1502 comprises four server computers, identified as SC₁, SC₂, SC₃, and SC₄, that are networked together to provide computational and network resources for virtual objects in a virtualization level 1504. The physical resources of the cluster 1502 are aggregated to create virtual resources for the virtual objects in the virtualization layer 1504. The sever computers SC₁, SC₂, SC₃, and SC₄ host virtual objects that include six VMs 1506-1511, three virtual switches 1512-1514, and two datastores 1516-1517. An example server computer, SC₅, host four VMs 1518-1521, a virtual switch 1522, and a data store 1524. In the example object topology of FIG. 15A, the server computers are represented in a first level of the object topology and the virtual objects are represented in a second level of the object topological. The applications, denoted by App₁, App₂, . . . , App₁₀, executing in the VMs are represented in a third level of the object topology. The server computers are parents with respect to the virtual objects (i.e., children) and the virtual objects are parents with respect to the applications (i.e., children). FIG. 15B shows a second example object topology for the objects shown in FIG. 15A. In this example, the virtual objects are separated into different levels and data center 1526 is represented as a parent of the server computers.

A performance problem with an object of a data center may be related to the behavior of other objects at different levels within an object topology. A performance problem with an object of a data center may be the result of abnormal behavior exhibited by another object at a different level of an object topology of a data center. Alternatively, a performance problem with an object of a data center may create performance problems at other objects located in different levels of the object topology. For example, the applications App₁, App₂, . . . , App₁₀ in FIGS. 15A-15B may be application components of a distributed application that share information. Alternatively, the applications App₁, App₂, . . . , App₆ may be application components of a first distributed application and the applications App₇, App₈, . . . , App₁₀ may be application components of a second distributed application in which the first and second distributed applications share information. When a performance problem arises with an object of the object topology, the performance problem may affect the performance of other objects of the object topology. FIG. 15B shows an example plot of a response time 1528 for App₄. In this example, the response time 1528 exceeds at a response time threshold 1530 at time tₑᵣᵣₒᵣ. In other words, the response time has shifted above the threshold 1530. However, the cause of the increased response time may be due to a performance problem with one or more other objects of the object topology for which no performance problems have been detected.

Methods and systems now described are directed to finding various types of evidence of performance problems with objects in an object topology of a data center. The methods and systems detect changes that correspond to performance problems with objects for which no alerts and parameters for detecting the performance problems have been defined or detect performance problems related to alerts that fail to point to a cause of the performance problem. Methods and systems may also include troubleshooting performance problems and generating recommendations for correcting the performance problems.

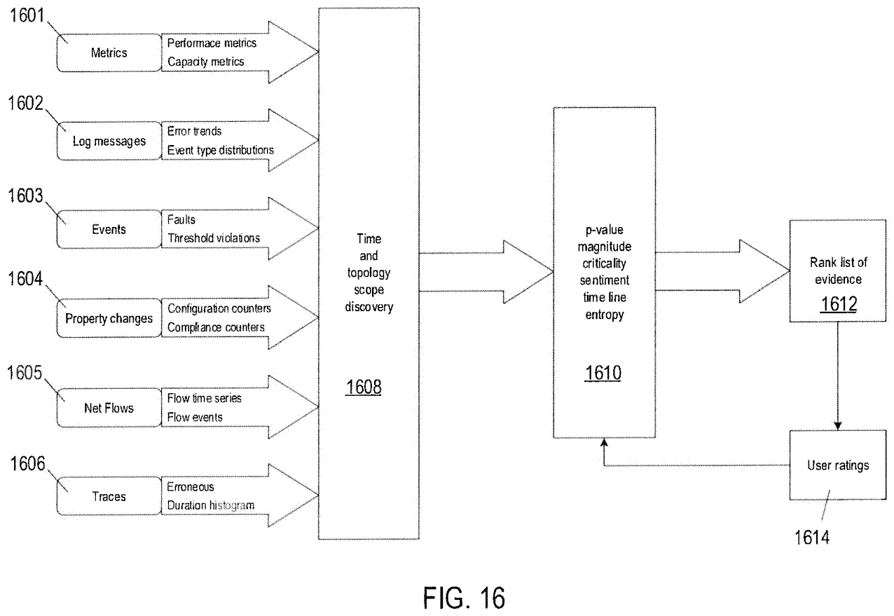

FIG. 16 shows an overview of a method for finding various types of evidence performance problems with objects of an object topology of a data center. Methods collect object information associated with objects of an object topology. The object information comprises metrics 1601, log messages 1602, events 1603, change properties 1604, network flows 1605, and application traces 1606. Block 1608 represents receiving the object information, a time called a “performance problem time” that is selected by a user, a troubleshooting time period in which to search for various types of evidence of changes in the object information that correspond to performance problems, and an object topology determined by the operations manager 1332. Let Tₚₚ be a user selected performance problem time in the troubleshooting time period. The performance problem time Tₚₚ may be a point in time when an error in execution of an application or object has been detected for a key performance indicator (“KPI”). Examples of a KPI for an application, a VM, or a server computer include average response times, error rates, or a peak response time. A user selects a troubleshooting time period that encompasses the time Typ. An example of the time Tₚₚ may be the time, tₑᵣᵣₒᵣ, represented in FIG. 15B and the response time 1528 of the application App₄ is an example of a KPI. Block 1610 represents various operations performed on the object information to detect various types of evidence of changes that correspond to performance problems. The various types of evidence are described separately below. A rank is computed for each type of evidence. Block 1612 represents rank ordering the evidence based on the associated ranks. A user may determine that certain evidence is more valuable than other evidence in detecting performance problems. Block 1614 represents adding user ratings to the different types of ranked evidence. The operations represented by blocks 1610, 1612, and 1614 may be repeated for the same objects of the object topology or for objects of a different object topology of the data center.

Based on the various types of evidence, a user may identify a performance problem associated with the various types of evidence and determine corresponding remedial measures for correcting the performance problem. The performance problems and corresponding types of evidence and remedial measures may be stored so that the information may be used to correct the same or similar performance problems in the future. Methods and systems may identify the problem and generate recommended remedial measures for correcting a performance problem when the same types of evidence are detected, enabling users to quickly correct performance problems in the data center.

Evidence of Change Points in Metric Data

The operations manager 1332 numerous streams of time-dependent metric data from objects of the object topology. Each stream of metric data is time series data that may be generated by an operating system, a resource, or by an object itself. A stream of metric data associated with a resource comprises a sequence of time-ordered metric values that are recorded in spaced points in time called “time stamps.” A stream of metric data is simply called a “metric” and is denoted by

v(t)=(xᵢ)ᵢ₌₁^{N}=(tᵢ))ᵢ₌₁^{N} (1)

where
v denotes the name of the metric;
N is the number of metric values in the sequence;
xᵢ=x(tᵢ) is a metric value;
tᵢ is a time stamp indicating when the metric value was recorded in a data-storage device; and
subscript i is a time stamp index i=1, . . . , N.

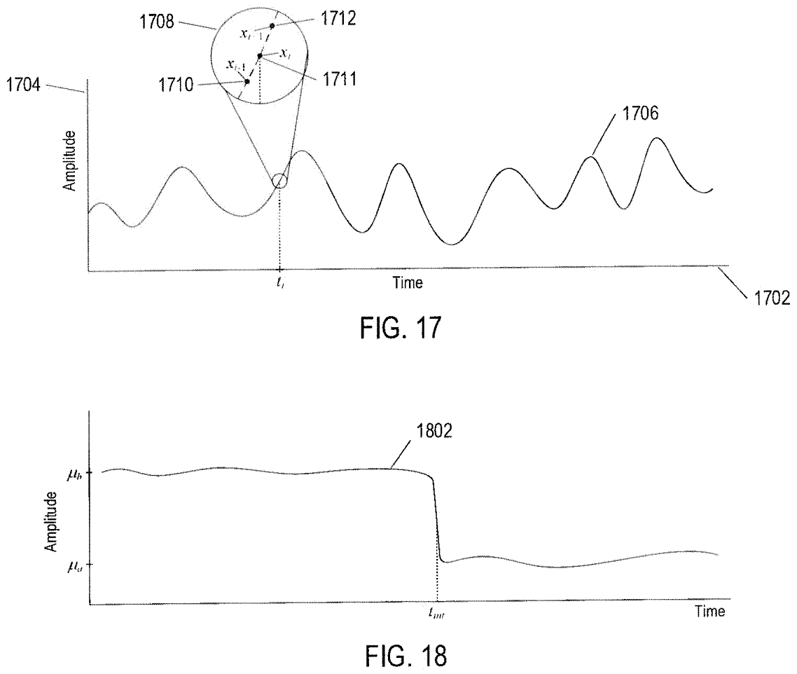

FIG. 17 shows a plot of an example metric. Horizontal axis 1702 represents time. Vertical axis 1704 represents a range of metric value amplitudes. Curve 1706 represents a metric as time series data. In practice, a metric comprises a sequence of discrete metric values in which each metric value is recorded in a data-storage device. FIG. 17 includes a magnified view 1708 of three consecutive metric values represented by points. Each point represents an amplitude of the metric at a corresponding time stamp. For example, points 1710-1712 represent consecutive metric values (i.e., amplitudes) xᵢ₋₁, xᵢ, and xᵢ₊₁ recorded in a data-storage device at corresponding time stamps tᵢ₋₁, tᵢ, and tᵢ₊₁. The example metric may represent usage of a physical or virtual resource. For example, the metric may represent CPU usage of a core in a multicore processor of a server computer over time. The metric may represent the amount of virtual memory a VM uses over time. The metric may represent network throughput for a server computer. Network throughput is the number of bits of data transmitted to and from a physical or virtual object and is recorded in megabits, kilobits, or bits per second. The metric may represent network traffic for a server computer. Network traffic at a physical or virtual object is a count of the number of data packets received and sent per unit of time. The metric may also represent object performance, such as CPU contention, response time to requests, and wait time for access to a resource of an object.

Methods detect changes in metrics over the troubleshooting time period. The changes may correspond to performance problems that are active in the troubleshoot time period. Metrics with a single spike or single drop in metric values are not of interest. Instead methods detect changes that have lasted for a longer period of time or are still active. Of particular interest are metrics in which the mean value of metric values has changed over time.

FIG. 18 shows a plot of an example metric in which the mean value for metric values of the metric have shifted. Curve 1802 represents metric values recorded over time. Prior to time, tᵢₙₜ, metric values are centered around a mean b. After the time tᵢₙₜ, metric values are centered around a mean μₐ, which indicates the metric values abruptly changed after time tᵢₙₜ.

A change point is detected by computing a U statistic for a sliding time window within the longer troubleshooting time period. The sliding time is partitioned into a left-hand window and a right-hand window. The statistic is computed for metric values in the left-hand and right-hand windows and is given by:

$$\begin{matrix}{U}_{t , T} = {\sum }_{i = 1}^{t} {\sum }_{j = t + 1}^{T} {D}_{i j} & ( 2 ) \\ where & \\ {D}_{i j} = sgn ( {x}_{i} - {x}_{j} ) = \{ \begin{matrix}1 & {x}_{i} < {x}_{j} \\ 0 & {x}_{i} = {x}_{j} ; \\ - 1 & {x}_{i} > {x}_{j}\end{matrix} & \end{matrix}$$

xᵢ are metric values in the left-hand window;
xⱼ are metric values in the right-hand window;
1≤t<T;
t is the largest time value in the left-hand window; and
T is the number of points in the sliding time window.
   The value of the U statistic U_{t,T} is calculated based on sign differences between data within the left-hand and right-hand time windows. Note that the U statistic U_{t,T} does not consider the magnitude of the difference between metric values xᵢ and xⱼ. As a result, a single large spike in the left-hand window or the right-hand window does not affect change point detection in the sliding time window.

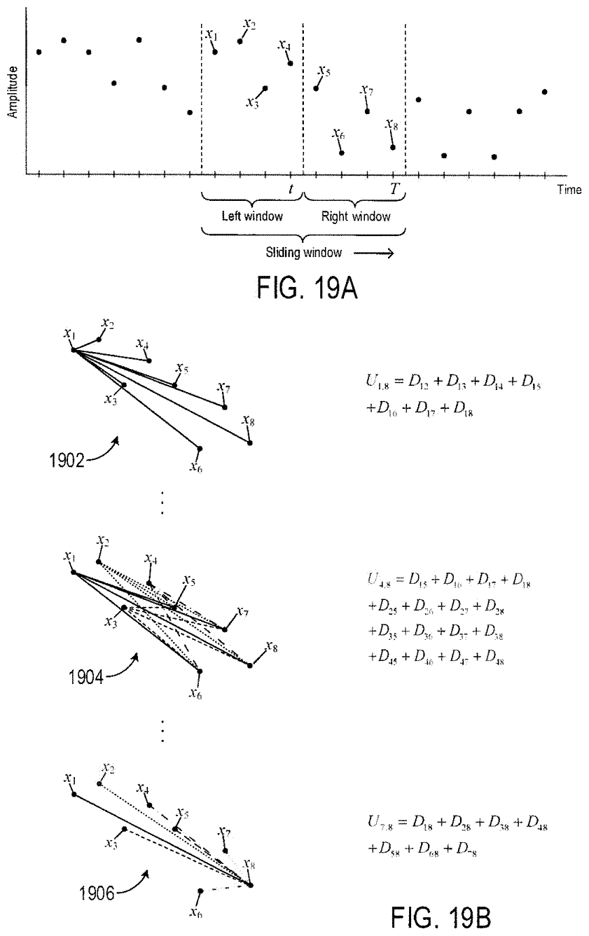

FIG. 19A shows a plot of time-series metric data within a sliding time window. Metric values within the sliding time window are denoted by xᵢ, where i=1, 2, . . . , 8 are indices of metric values in sliding time window. The left-hand window contains the metric values x₁, x₂, x₃, and x₄. The right-hand window contains the metric values x₅, x₆, x₇, and x₈. In this example, the metric time index 4 correspond to t in Equation (2) and index 8 corresponds to T in Equation (2). FIG. 19B shows graphs and the U statistic U_{t,T} computed for metric values in the left-hand and right-hand windows of the sliding time window. FIG. 19B shows graphs with the metric values represented by nodes. Lines between the metric values identify the pair metric values that are used to compute D_{i,j} in the U statistic U_{t,T}. For example, graph 1902 represents calculation of the statistic U_{1,8}. Graph 1904 represents calculation of the U statistic U_{4,8} with different line patterns representing different parts of the sum of the U statistic. For example, dotted lines in graph 1904 represent the sum D₂₅+D₂₆+D₂₇+D₂₈ in the statistic U_{4,8}.

A non-parametric test statistic for the sliding time window is given by

$${K}_{T} = {max}_{1 \leq t < T} \vert {U}_{t , T} \vert \qquad ( 3 )$$

A p-value of the non-parametric test statistic K_{T} is given by

$$p ≅ 2 exp ( \frac{- 6 {( {K}_{T} )}^{2}}{{T}^{3} + {T}^{2}} ) \qquad ( 4 )$$

A change point at the time, t, is significant when the following condition is satisfied

p<Th_{con} (5)

where Th_{con} is a confidence threshold (e.g., Th_{con}, equals 0.05, 0.04, 0.03, 0.02, or 0.01).

In other words, when the condition in Equation (5) is satisfied, the change in amplitude of the metric values in the left-hand window and the right-hand window is significant.

In another implementation, a permutation test may be applied to the U statistic in the left-hand and right-hand windows. Let the set of U statistics computed for the left-hand window be given by U_{1,T}_{_{L}}, . . . , U_{L,T}_{_{L}}, where 1≤L<T_{L} and T_{L} is the number of points in the left-hand window. Let the set of U statistics computed for the right-hand window be given by U_{1,T}_{_{R}}, . . . , U_{R,T}_{_{R}}, where 1≤R<T_{R} and T_{R} is the number of points in the right-hand window. Note that for the sliding time window T=T_{L}+T_{R}. Let the test statistic be given by

$$Test ( {U}_{1 , {T}_{L}} , … , {U}_{L , {T}_{L}} , {U}_{1 , {T}_{R}} , … , {U}_{R , {T}_{R}} ) = \vert {\overline{U}}_{L , {T}_{L}} - {\overline{U}}_{R , {T}_{R}} \vert \\ where$$

$${\overline{U}}_{L , {T}_{L}} = \frac{1}{L} {\sum }_{i = 1}^{L} {U}_{i , {T}_{L}} \begin{matrix}is the sample mean U statistic for \\ the left - handed window ;\end{matrix}$$

$${\overline{U}}_{R , {T}_{R}} = \frac{1}{R} {\sum }_{i = 1}^{R} {U}_{i , {T}_{R}} \begin{matrix}is the sample mean U statistic for \\ the right - handed window .\end{matrix}$$

Let M=L+R and form M! permutations of the U statistics U_{1,T}, . . . , U_{L,T}_{_{L}}, U_{1,T}, . . . , U_{R,T}_{_{R}}. For each permutation, the test statistic Test is computed. The values for permutations of the test statistic are denoted by Test₁, . . . , Test_{M!}. Under the null hypothesis these values are equally likely. The p-value is given by

$$p = \frac{1}{M !} {\sum }_{j = 1}^{M !} I ( {Test}_{j} > {U}_{j , T} )$$

where
T is over the left-hand and right-hand windows; and

$$I ( {Test}_{j} > {U}_{j , T} ) = \{ \begin{matrix}1 & for {Test}_{j} > {U}_{j , T} \\ 0 & for {Test}_{j} \leq {U}_{j , T}\end{matrix}$$

If the p-value satisfies the condition in Equation (5), then the distributions of metric values in the left-hand and right-hand windows are different and a change point occurs between the left-hand and right-hand windows.

After a change point has been detected in the sliding time window according to Equation (5), the magnitude of the change is computed by

$$Change - Magnitude = \frac{\vert {median ( {x}_{i} )}_{L W} - {median ( {x}_{i} )}_{R W} \vert}{{max}_{1 \leq i \leq T} ( {x}_{i} ) - {min}_{1 \leq i \leq T} ( {x}_{i} )} \qquad ( 6 )$$

where
median(xᵢ)_{LW} is the median of the metric values in the left-hand window; and
median(xᵢ)_{RW} is the median of the metric values in the right-hand window.
   The change in metric values within the sliding time window is identified as significant when the change magnitude satisfies the following condition

Change−Magnitude>Th_{mag} (7)

where Th_{mag} is a change magnitude threshold (e.g., Th_{mag}=0.05). When the condition given by Equation (7) is satisfied, the time, t, of the sliding time window is confirmed as a change point and is denoted by t_{cp}.

Each metric with a change point in the troubleshooting time period may be assigned a rank based on a corresponding p-value and closeness in time of the change point to the point in time Tₚₚ. For example, the rank for metric with a change point in the troubleshooting time period may calculated by

$$\begin{matrix}Rank ( metric ) = {w}_{1} Closeness ( {t}_{cp} ) + {w}_{2} p - value & ( 8 ) \\ where & \\ Closeness ( {t}_{cp} ) = \frac{1}{time - difference ( {t}_{cp} - {T}_{pp} )} & ( 9 a )\end{matrix}$$

The parameters w₁ and w₂ in Equation (8) are weights that are used to give more influence to either the closeness or the p-value. For example, the weights may range from 0≤wᵢ≤1, where i=1, 2. In Equation (9a), the closeness of the change point t_{cp} to the time Tₚₚ increases in magnitude the closer the change point t_{cp} is to the time Tₚₚ. In another implementation, it may be desirable to rank metrics with change points t_{cp} that are further away from the time Tₚₚ higher than change points t_{cp} that are closer to the time Tₚₚ as follows:

Closeness(t_{cp})=time−difference(t_{cp}−Tₚₚ) (9b)

Evidence of Changes in Log Messages

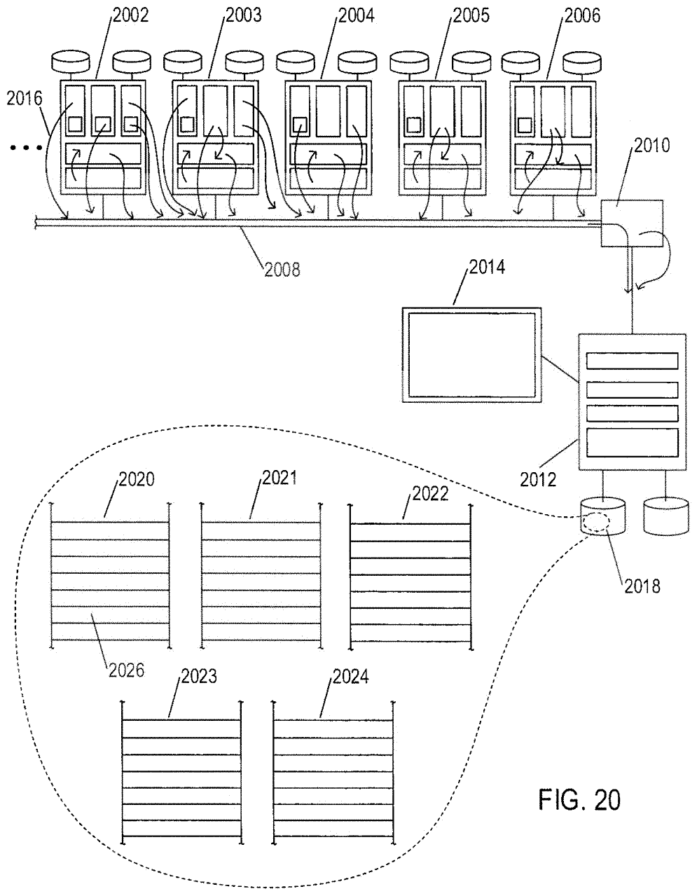

Methods obtain evidence performance problem of changes in log messages generated by objects of an object topology over the troubleshooting time period. FIG. 20 shows an example of logging log messages in log files. In FIG. 20, computer systems 2002-2006 within a data center are linked together by an electronic communications medium 2008 and additionally linked through a communications bridge/router 2010 to an administration computer system 2012 that includes an administrative console 2014 and executes a log management server. For example, the administration computer system 2012 may be the server computer 1308 in FIG. 13 and the log management server may be part of the operations manager 1332. Each of the computer systems 2002-2006 may run a log monitoring agent that forwards log messages to the log management server executing on the administration computer system 2012. As indicated by curved arrows, such as curved arrow 2016, multiple components within each of the discrete computer systems 2002-2006 as well as the communications bridge/router 2010 generate log messages that are forwarded to the log management server. Log messages may be generated by any event source. Event sources may be, but are not limited to, application programs, operating systems, VMs, guest operating systems, containers, network devices, machine codes, event channels, and other computer programs or processes running on the computer systems 2002-2006, the bridge/router 2010 and any other components of a distributed computing system. Log messages may be received by log monitoring agents at various hierarchical levels within a discrete computer system and then forwarded to the log management server. The log messages are recorded in a data-storage device or appliance 2018 as log files 2020-2024. Rectangles, such as rectangle 2026, represent individual log messages. For example, log file 2020 may contain a list of log messages generated within the computer system 2002. Each log monitoring agent has a configuration that includes a log path and a log parser. The log path specifies a unique file system path in terms of a directory tree hierarchy that identifies the storage location of a log file on the administration computer system 2012 or the data-storage device 2018. The log monitoring agent receives specific file and event channel log paths to monitor log files and the log parser includes log parsing rules to extract and format lines of the log message into log message fields described below. Each log monitoring agent sends a constructed structured log message to the log management server. The administration computer system 2012 and computer systems 2002-2006 may function without log monitoring agents and a log management server, but with less precision and certainty.

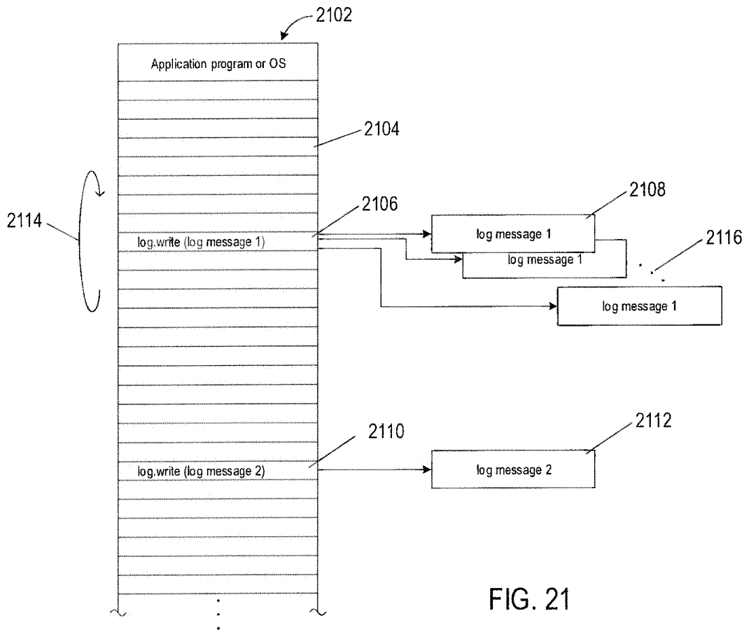

FIG. 21 shows an example source code 2102 of an event source, such as an application, an operating system, a VM, a guest operating system, or any other computer program or machine code that generates log messages. The source code 2102 is just one example of an event source that generates log messages. Rectangles, such as rectangle 2104, represent a definition, a comment, a statement, or a computer instruction that expresses some action to be executed by a computer. The source code 2102 includes log write instructions that generate log messages when certain events predetermined by a developer occur during execution of the source code 2102. For example, source code 2102 includes an example log write instruction 2106 that when executed generates a “log message 1” represented by rectangle 2108, and a second example log write instruction 2110 that when executed generates “log message 2” represented by rectangle 2112. In the example of FIG. 21, the log write instruction 2108 is embedded within a set of computer instructions that are repeatedly executed in a loop 2114. As shown in FIG. 21, the same log message 1 is repeatedly generated 2116. The same type of log write instructions may also be in different places throughout the source code, which in turns creates repeats of essentially the same type of log message in the log file.

In FIG. 21, the notation “log.write( )” is a general representation of a log write instruction. In practice, the form of the log write instruction varies for different programming languages. In general, log messages are relatively cryptic, including generally only one or two natural-language words and/or phrases as well as various types of text strings that represent file names, path names, and, perhaps various alphanumeric parameters that may identify objects, such as VMs, containers, or virtual network interfaces. In practice, a log write instruction may also include the name of the source of the log message (e.g., name of the application program, operating system and version, server computer, and network device) and the name of the log file to which the log message is recorded. Log write instructions may be written in a source code by the developer of an application program or operating system in order to record events that occur while an operating system or application program is executing. For example, a developer may include log write instructions that record events including, but are not limited to, information identifying startups, shutdowns, I/O operations of applications or devices; errors identifying runtime deviations from normal behavior or unexpected conditions of applications or non-responsive devices; fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

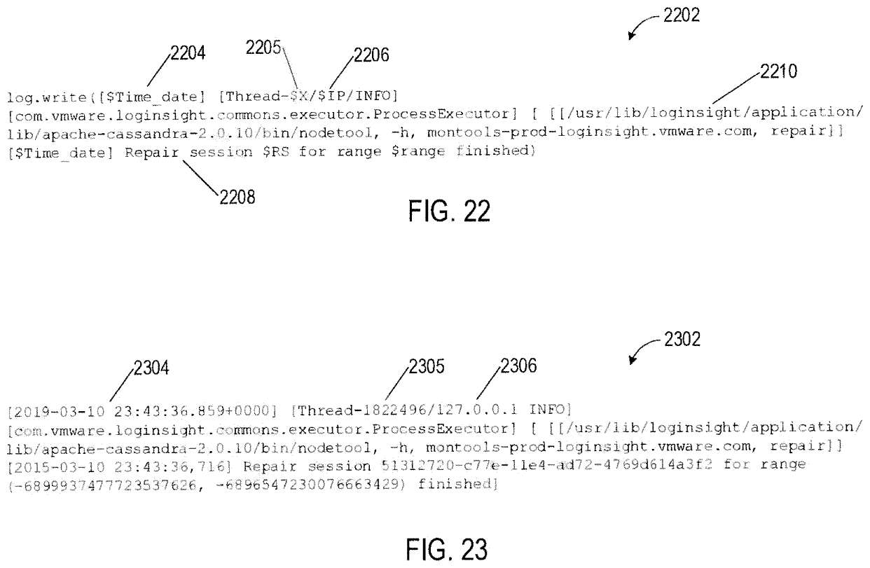

FIG. 22 shows an example of a log write instruction 2202. In the example of FIG. 22, the log write instruction 2202 includes arguments identified with “$.” For example, the log write instruction 2202 includes a time-stamp argument 2204, a thread number argument 2205, and an internet protocol (“IP”) address argument 2206. The example log write instruction 2202 also includes text strings and natural-language words and phrases that identify the type of event that triggered the log write instruction, such as “Repair session” 2208. The text strings between brackets “[ ]” represent file-system paths, such as path 2210. When the log write instruction 2202 is executed by a log management agent, parameters are assigned to the arguments and the text strings and natural-language words and phrases are stored as a log message of a log file.

FIG. 23 shows an example of a log message 2302 generated by the log write instruction 2202. The arguments of the log write instruction 2202 may be assigned numerical parameters that are recorded in the log message 2302 at the time the log message is written to the log file. For example, the time stamp 2204, thread 2205, and IP address 2206 arguments of the log write instruction 2202 are assigned corresponding numerical parameters 2304-2306 in the log message 2302. The time stamp 2304 represents the date and time the log message is generated. The text strings and natural-language words and phrases of the log write instruction 2202 also appear unchanged in the log message 2302 and may be used to identify the type of event (e.g., informative, warning, error, or fatal) that occurred during execution of the event source.

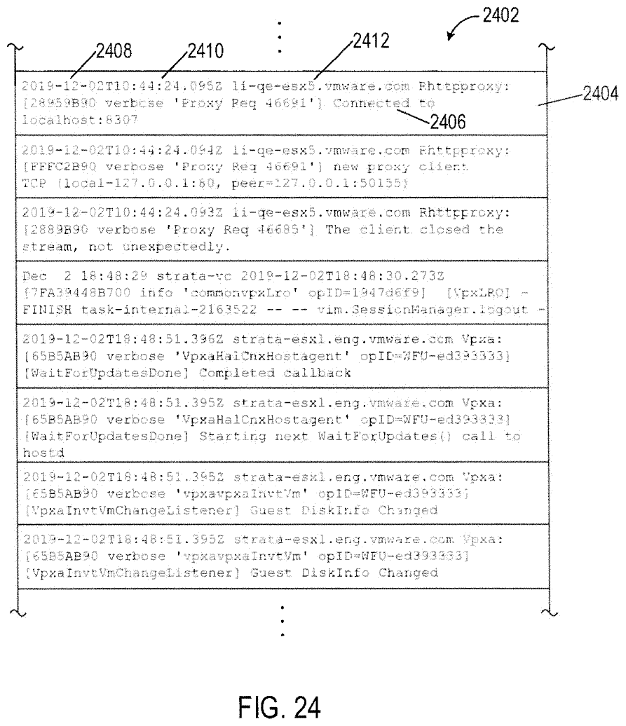

As log messages are received from various event sources, the log messages are stored in corresponding log files in the order in which the log messages are received. FIG. 24 shows an example of eight log message entries of a log file 2402. In FIG. 24, each rectangular cell, such as rectangular cell 2404, of the portion of the log file 2402 represents a single stored log message. For example, log message 2402 includes a short natural-language phrase 2406, date 2408 and time 2410 numerical parameters, as well as, an alphanumeric parameter 1812 that appears to identify a host computer.

Methods perform event analysis on each log message generated in the troubleshooting time period. Event analysis discards stop words, numbers, alphanumeric sequences, and other information from the log message that is not helpful to determining the event described in the log message, leaving plaintext words called “relevant tokens” that may be used to determine the state of the object.

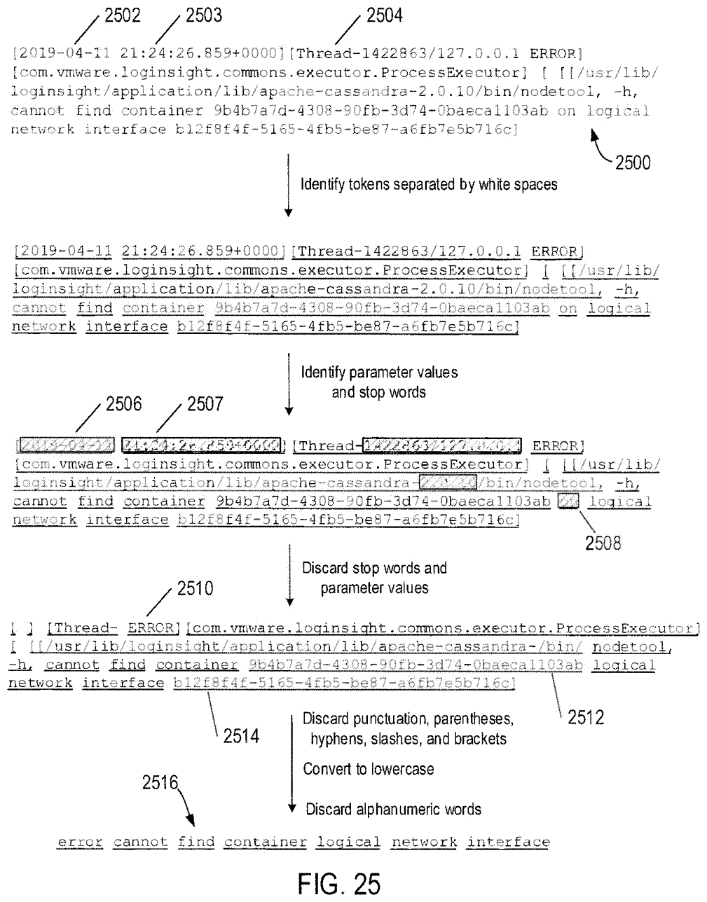

FIG. 25 shows an example of event analysis performed on an example error log message 2500. The error log message 2500 is tokenized by considering the event message as comprising tokens separated by non-printed characters, referred to as “white spaces.” Tokenization of the error log message 2500 is illustrated by underlining of the printed or visible tokens comprising characters. For example, the date 2502, time 2503, and thread 2504 of the header are underlined. Next, a token-recognition pass is made to identify stop words and parameters. Stop words are common words, such as “they,” “are,” “do,” etc. do carry any useful information. Parameters are tokens or message fields that are likely to be highly variable over a set of messages of a particular type, such as date/time stamps. Additional examples of parameters include global unique identifiers (“GUIDs”), hypertext transfer protocol status values (“HTTP statuses”), universal resource locators (“URLs”), network addresses, and other types of common information entities that identify variable aspects of an event. Stop words and parametric tokens are indicated by shading, such as shaded rectangle 2506, 2507, and 2508. Stop words and parametric tokens are discarded leaving the non-parametric text strings, natural language words and phrases, punctuation, parentheses, and brackets. Various types of symbolically encoded values, including dates, times, machine addresses, network addresses, and other such parameters can be recognized using regular expressions or programmatically. For example, there are numerous ways to represent dates. A program or a set of regular expressions can be used to recognize symbolically encoded dates in any of the common formats. It is possible that the token-recognition process may incorrectly determine that an arbitrary alphanumeric string represents some type of symbolically encoded parameter when, in fact, the alphanumeric string only coincidentally has a form that can be interpreted to be a parameter. The currently described methods and systems do not depend on absolute precision and reliability of the event-message-preparation process. Occasional misinterpretations do not result in mischaracterizing log messages. The event message 2000 is subject to textualization in which an additional token-recognition step of the non-parametric portions of the log message is performed in order to discard punctuation and separation symbols, such as parentheses and brackets, commas, and dashes that occur as separate tokens or that occur at the leading and trailing extremities of previously recognized non-parametric tokens. Uppercase letters are converted to lowercase letters. For example, letters of the word “ERROR” 2510 may converted to “error.” Alphanumeric words 2512 and 2514, such as interface names and universal unique identifiers, are discarded, leaving plaintext relevant tokens 2516.

The plaintext relevant tokens may be used to classify the log messages as error, warning, or information. Methods determine trends in error, warning, and information log messages generated within the troubleshooting time period. Relative frequencies of error messages may be computed in time intervals of the troubleshooting time period as follows;

$$\begin{matrix}R {F}_{e r r} = \frac{n ( {event}_{e r r} )}{{N}_{i n t}} & ( 10 a ) \\ R {F}_{wαrm} = \frac{n ( {event}_{warn} )}{{N}_{int}} & ( 10 b ) \\ and & \\ R {F}_{info} = \frac{n ( e v e n {t}_{info} )}{{N}_{int}} & ( 10 c )\end{matrix}$$

where
Nᵢₙₜ is the number of log messages generated in a time interval (tᵢ, tᵢ₊₁];
n(etₑᵣᵣ) is the number error log messages generated in the interval (tᵢ, tᵢ₊₁];
n(et_{warn}) is the number warning log messages generated in the interval (tᵢ, tᵢ₊₁]; and
n(et_{info}) is the number informational log messages generated in the interval (tᵢ,tᵢ₊₁].

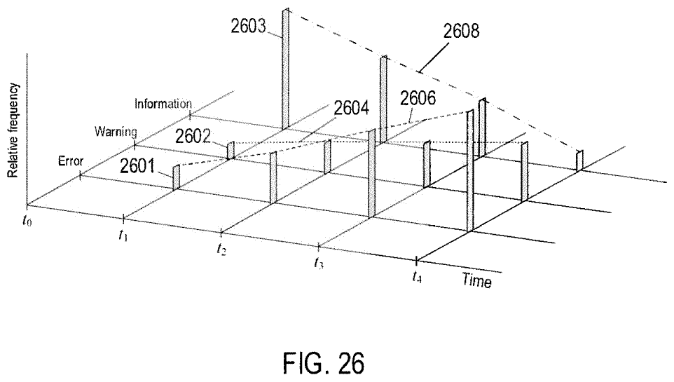

FIG. 26 shows a plot of examples of trends in error, warning, and informational log messages. Suppose time t₀ represents the beginning of the troubleshooting time period and time t₄ represents the end of the troubleshooting time period. Bars represent relative frequencies of error, warning, and informational log messages generated by objects of the object topology within time intervals (tᵢ, tᵢ₊₁], where i=1, 2, 3, 4. For example, bars 2601-2603 represent relative frequencies of error, warning, and informational log messages with time stamps in time interval (t₀, t₁]. In this example, dashed line 2604 and dotted line 2606 reveal that corresponding error and warning log messages are increasing with time. By contrast, dot-dashed line 2608 reveals that information log message are decreasing over the same period of time.

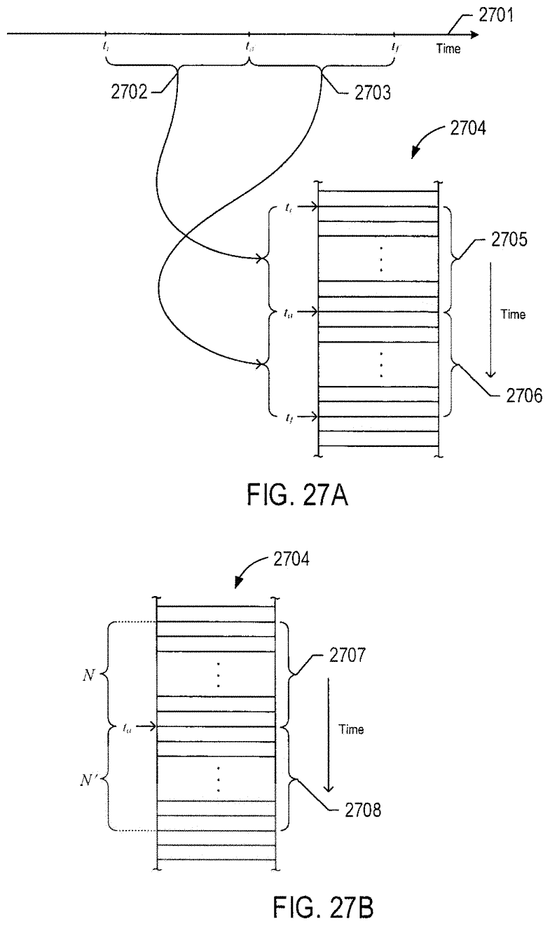

Methods include detecting a change in event-type distributions for the left-hand and right-hand time windows of the sliding time window applied to the troubleshooting time period. FIG. 27A shows a time axis 2701 with a time tₐ that partitions a sliding time window into left-hand time window 2702 defined by tᵢ≤ₜ<tₐ, where tᵢ is a time less than the time tₐ and right-hand time window 2703 defined by tₐ<t≤t_{f}, where t_{f} is a time greater than the time tₐ. For example, the time tₐ may be assigned the time t in Equation (2) above. The durations of the left-hand and right-hand time windows may be equal (i.e., tₐ−tᵢ=t_{f}−tₐ). FIG. 27A also shows a portion of a log file 2704 with event messages generated by objects of the object topology. Rectangles 2705 represent log messages recorded in the log file 2704 with time stamps in the left-hand time window 2702. Rectangles 2706 represent log messages recorded in the log file 2704 with time stamps in the right-hand time window 2703.

In other implementations, rather than considering log messages generated within corresponding left-hand and right-hand time windows, fixed numbers of log messages that are generated closest to the time tₐ may be considered. FIG. 27B shows obtaining fixed numbers of log messages recorded before and after time tₐ, where N is the number of log messages recorded with time stamps that precede the time tₐ and N′ is the number of log messages with time stamps that follow the time tₐ. In certain embodiments, the fixed numbers N and N′ may be equal.

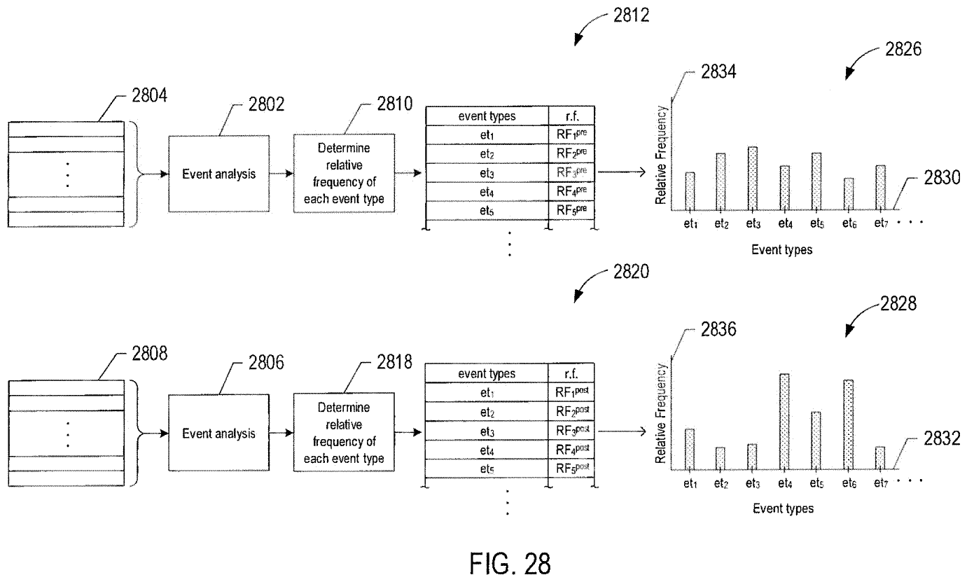

FIG. 28 shows event-type logs obtained from corresponding left-hand and right-hand time windows recorded in the log file 2704. In block 2802, event analysis is applied to each log message of the log messages 2804 recorded before (i.e., pre-log messages) the time tₐ in order to determine the event type of each log message in the log messages 2804. In block 2806, event analysis is also applied to each log message of log messages 2808 recorded after (i.e., post-log messages) time tₐ in order to determine the event type of each log message in the log messages 2808. The log messages 2804 and 2808 may be obtained as described above with reference to FIGS. 27A-27B. Event analysis applied in blocks 2802 and 2806 to each event message of the log messages 2804 and 2808 reduces the event message to text strings and natural-language words and phrases (i.e., non-parametric tokens). In block 2810, relative frequencies of the event types of the log messages 2804 are computed. For each event type of the log messages 2804, the relative frequency is given by

$$R {F}_{k}^{p r e} = \frac{{n}_{p r e} ( e {t}_{k} )}{{N}_{pre}} \qquad ( 11 a )$$

where
nₚᵣₑ(etₖ) is the number of times the event type etₖ appears in the pre-alert event messages; and
Nₚᵣₑ is the total number of log messages 2804.
   An event-type log 2812 is formed from the different event types and associated relative frequencies. In block 2818, relative frequencies of the event types of the log messages 2808 are computed. For each event type of the messages 2808, the relative frequency is given by

$$R {F}_{k}^{p o s t} = \frac{{n}_{p o s t} ( e {t}_{k} )}{{N}_{p o s t}} \qquad ( 11 b )$$

where
nₚₒₛₜ(etₖ) is the number of times the event type etₖ appears in the post-alert event messages; and
Nₚₒₛₜ is the total number of post-alert event messages.
   An event-type log 2820 is formed from the different event types and associated relative frequencies.

FIG. 28 shows a histogram 2826 of a pre-time tₐ event type distribution and a histogram 2828 of a post-time tₐ event type distribution. Horizontal axes 2830 and 2832 represent the event types. Vertical axes 2834 and 2836 represent relative frequency ranges. Shaded bars represent the relative frequency of each event type. In the example, of FIG. 28, the pre-time tₐ event type distribution 2826 and the post-time tₐ event type distribution 2828 display differences in the relative frequencies of certain event types both before and after the time tₐ the relative frequencies of other event types appear unchanged before and after the alert. For example, the relative frequency of the event type et₁ did not change before and after the time tₐ. By contrast, the relative frequencies of the event types et₄ and et₆ increased significantly after the time tₐ, which may an indication of a performance problem.

Methods compute a similarity between pre-time tₐ event-type distribution and the post-time tₐ event-type distribution. The similarity provides a quantitative measure of a change to the object associated with the log messages. The similarity indicates how much the relative frequencies of the event types in the pre-time tₐ event-type distribution differ from the same event types of the post-time tₐ event-type distribution.

In one implementation, a similarity may be computed using the Jensen-Shannon divergence between the pre-alert event type distribution and the post-alert event type distribution:

$$S i {m}_{J S} ( {t}_{a} ) = - {\sum }_{k = 1}^{K} {M}_{k} log {M}_{k} + \frac{1}{2} [ {\sum }_{k = 1}^{K} {P}_{k} log {P}_{k} + {\sum }_{k = 1}^{K} {Q}_{k} log {Q}_{k} ] \qquad ( 12 )$$

where
Pₖ=RFₖ^{pre}
Qₖ=RFₖ^{post}; and
Mₖ=(Pₖ+Qₖ)/2.
   In another implementation, the similarity may be computed using an inverse cosine as follows:

$$S i {m}_{CS} ( {t}_{a} ) = 1 - \frac{2}{π} {cos}^{- 1} [ \frac{{Σ}_{k = 1}^{K} {P}_{k} {Q}_{k}}{\sqrt{{{Σ}_{k = 1}^{K} ( {P}_{k} )}^{2}} \sqrt{{{Σ}_{k = 1}^{K} ( {Q}_{k} )}^{2}}} ] \qquad ( 13 )$$

The similarity is a normalized value in the interval [0,1] that may be used to measure how much, or to what degree, the pre-time tₐ event-type distribution differs from the post-time tₐ event-type distribution. The closer the similarity is to zero, the closer the pre-time tₐ event-type distribution and the post-time tₐ event-type distribution are to one another. For example, when Sim_{jS}(tₐ)=0, the pre-time tₐ event-type distribution and the post-time tₐ event-type distribution are identical. On the other hand, the closer the similarity is to one, the farther the pre-time tₐ event-type distribution and the post-time tₐ event-type distribution are from one another. For example, when Sims_{jS}(tₐ)=1, the pre-time tₐ event-type distribution and the post-time tₐ event-type distribution are as far apart from one another as possible.

The time tₐ may be identified as a change point when the following condition is satisfied

0<Thₛᵢₘ≤Sim(tₐ)≤1 (14)

where
Thₛᵢₘ is a similarity threshold; and
Sim(tₐ) is Sim_{jS}(tₐ) or Sim_{CS}(tₐ).
   In other embodiments, deviations from a baseline event-type distribution may be used to compute the change point as described U.S. Pat. No. 10,509,712, which is owned by VMware, Inc. and is herein incorporated by reference.

The log messages generated after the change point tₐ in the troubleshooting time period may be ranked based on the similarity and closeness in time of the change point tₐ to the point in time Tₚₚ. For example, the rank of an object in the object topology may be calculated by

Rank(Object)=w₁Closeness(tₐ)+w₂Sim(tₐ) (15)

The Closeness(tₐ) may be calculated using Equation (9a) or (9b) described above. The parameters w₁ and w₂ in Equation (8) are weights that are used to give more influence to either the closeness or the p-value. For example, the weights may range from 0≤wᵢ≤1, where i=1, 2.

Analysis of Adverse Event Evidence

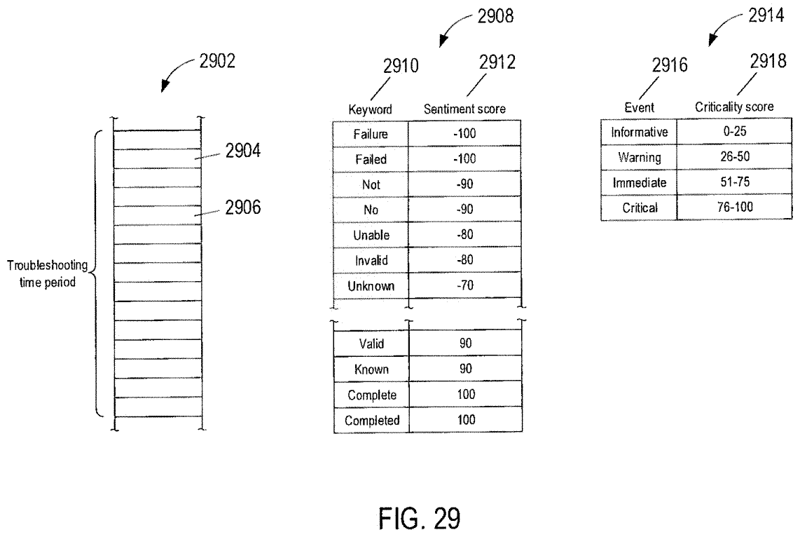

Methods include analyzing events associated with the object topology for evidence of changes in associate with adverse events that may have been triggered and remain active during the troubleshooting time period. The adverse events include faults, change events, notifications, and dynamic threshold violations. Dynamic threshold violations occur when metric values of a metric exceeds a dynamic threshold. Note that hard threshold violations are excluded from consideration because hard threshold violations are part of alert definitions. Adverse events may be recorded in log messages generated during the troubleshooting time period as described above. Each adverse event may be ranked according to one or more of the following criteria: a sentiment score, criticality score, active or cancelled status of the event, closeness in time to the point in time Tₚₚ, frequency of the event in the troubleshooting time period, and entropy of the event. Calculation of the sentiment score and the criticality score is described below with reference to FIG. 29.

FIG. 29 shows determination of a sentiment score and criticality score for a list of adverse events 2902 recorded in the troubleshooting time period. Each rectangle represents an event entry in the list of events 2902, such as a fault, a change event, a notification, or a dynamic threshold violation of metric, reported to the operations manager 1332 in the troubleshooting time period. Each event has an associated time stamp. For example, entry 2904 may represent metric values of a metric associated with an object that violates a dynamic threshold violation. The metric and time of the dynamic threshold violation are recorded in the entry 2902. Entry 2906 may record an event and time stamp of a log message associated with an object. An average sentiment score may be calculated for each entry in the list of events 2902 using a sentiment score table 2908. The sentiment score table 2908 includes a list of keywords 2910 and a list of associated sentiment scores 2912. For example, suppose event analysis applied to the log message recorded in entry 2906 reveals that the log message contains the plain text words: error, cannot, find, container, logical, network, and interface, as described above with reference to FIG. 25. Suppose these words are assigned the corresponding sentiment scores: 100, 90, 00, 0, 0, and 0. The average sentiment score for the entry 2906 is 95. FIG. 29 also shows a criticality table 2912 that may be used to assign a criticality score to entries in the list of events 2902. For example, if the values of the metrics that violated the dynamic threshold recorded in entry 2904 correspond to a warning, the event recorded in entry 2904 may be assigned a criticality score between 26-50 that depends on how far the metric values are from the dynamic threshold.

The frequency of an adverse event in the troubleshooting time period is given by

$${f}_{event} = \frac{{n}_{e v e n t}}{{N}_{event}} \qquad ( 16 )$$

where
nₑᵥₑₙₜ is the number of times the same adverse event occurred in the troubleshooting time period; and
Nₑᵥₑₙₜ is the total number of events in the troubleshooting time period.
   The entropy of the adverse event is given by

H(fₑᵥₑₙₜ)=−log(fₑᵥₑₙₜ) (16)

Methods and systems may discard events, such as log messages and notification, that contain positive phrases, such as “completed with status \‘success\’”, “restored,” “succeeded,” and “sync completed.”

A rank for adverse event may be calculated as follows:

Rank(event)=w₁Ave_{SS}(event)+w₂CS(event)+w₃Closeness(event)+w₄H(fₑᵥₑₙₜ)+w₅Status(event) (18)

where
Ave_{SS}(event) is the average sentiment score for the event;

$$Closeness ( event ) = \frac{1}{{n}_{event}} {\sum }_{i = 1}^{{n}_{event}} Closeness ( {t}_{event , i} )$$

t_{event,i} is the time of the i-th occurrence of the event in the troubleshooting time period;
CS(event) is the criticality score for the event;
Status(event) represents the status of the event (e.g., Status(event)=1 if the event is active and Status(event)=0 if the event is cancelled.)
   In another implementation, the closeness of an event having more than one occurrence in the troubleshooting time period may be given by

$$Closeness ( event ) = {max}_{i} Closeness ( {t}_{event , i} )$$

The closeness Closeness(t_{event,i}) may be calculated as described above with reference to Equations (9a) and (9b). The parameters w₁, w₂, w₃, w₄, and w₅ in Equation (19) are weights that are used to give more influence to terms in Equation (19). For example, the weights may range from 0≤wᵢ≤1, where i=1, 2, . . . , 5.

Evidence of Property Changes

Methods determine evidence of a property change for an object in the troubleshooting time period based on property metrics associated with the object topology. Property change metrics include Boolean metrics and counter metrics. A Boolean metric represents the binary state of an object. The Boolean property metric may represent the ON and OFF state of an object, such as a server computer or a VM, over time. For example, when a server computer shuts down, the state of the server computer switches from ON to OFF which is recorded at a point in time. When the server computer is powered up the state of the server computer switches from OFF to ON which is recorded at a point in time. A counter metric represents a count of operations, such as processes or responses to client requests, executed by an object.

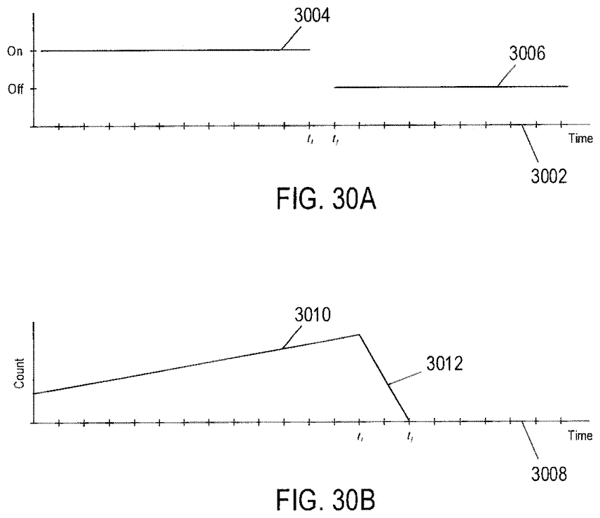

FIG. 30A show an example of a Boolean property metric associated with an object. Horizontal axis 3002 represents time. Marks along the horizontal axis represents points in time when the ON or OFF state of the object is recorded. Horizontal line 3004 represents the ON state of the object before time tᵢ. Horizontal line 3006 represents the OFF state of the object after time tⱼ. Somewhere between the times tᵢ and tⱼ the object switched from ON to OFF.

FIG. 30B show an example of a counter property metric associated with an object. Horizontal axis 3008 represents time. Marks along the horizontal axis represents points in time when a count of the number of operations executed by the object is recorded. Line 3006 represents the number of operations executed by the object before time tᵢ. After time tᵢ the number of operations executed by the object rapidly decreases to zero at time tⱼ and remains at zero.

Methods compute a frequency of a property change in the troubleshooting time period as follows:

$${f}_{c h a n g e} = \frac{{n}_{change}}{{N}_{prop}} \qquad ( 20 )$$

where
n_{change} is the number of times the property of an object changed in the troubleshooting time period (e.g., number of times the objects switched between ON and OFF states); and
Nₚᵣₒₚ is the total number of times the property of the object was recorded in the troubleshooting time period.
   The entropy of the property change in the troubleshooting time period is calculate by

H(f_{change})=−log(f_{change}) (21)

A rank of property changes with an object in the troubleshooting time period may be computed by

$$\begin{matrix}Rank ( prop\_metric ) = {w}_{1} Closeness ( prop\_change ) + {w}_{2} H ( {f}_{change} ) & \text{(22)} \\ where & \\ Closeness ( prop\_change ) = \frac{1}{{n}_{change}} {\sum }_{i = 1}^{{n}_{change}} Closeness ( {t}_{change , i} ) & \end{matrix}$$

t_{change,i} is the time of the property change.
   The parameters w₁ and w₂ are user assigned weights (e.g., the weights may range from 0<wᵢ≤1, where i=1, 2). In another implementation, the closeness of one occurrence of a property change in the troubleshooting time period may be given by

$$Closeness ( prop\_change ) = {max}_{i} Closeness ( {t}_{change , i} )$$

The closeness Closeness(t_{change,i}) may be calculated as described above with reference to Equations (9a) and (9b). The rank property change, Rank(prop_change), may be used to indicate the importance of the evidence of property changes taking place at the object.

Evidence of Changes in Network Data

Networks metrics for an object in the object topology are time series metrics that include, but are not limited to, percentage of packets dropped, data transmission rate, data receiver rate, and total throughput. Anomalous network flows occur when metric values of a network metric violate a dynamic threshold associated with the metric, creating network bottlenecks. Dynamic thresholding and detection of network metrics that violate dynamic thresholds are described in U.S. Pat. No. 10,241,887 which is owned by VMware Inc. and is herein incorporated by reference. A change point in the troubleshooting time period and p-values for the network metrics are computed as described above with reference to Equations (2)-(7). Each network metric may be ranked as follows:

Rank(net_metric)=w₁Closeness(t_{cp})+w₂p−value (23)

where
Closeness(t_{cp}) is the closeness of the change point to the time Tₚₚ (See Equations (9a) and (9b) above); and
p-value is the p-value for the network metric calculated according to Equations (2)-(4).
   The parameters w₁ and w₂ are user assigned weights (e.g., the weights may range from 0≤wᵢ≤1, where i=1, 2).
   The network metric rank, Rank(net_metric), may be used to indicate the importance of the evidence of a network bottleneck taking place at the object.

Evidence of Changes in Application Traces

Application traces and associated spans may also be used to detect evidence of performance problems with objects of the object topology. Distributed tracing is used to construct application traces and associated spans. A trace represents a workflow executed by an application, such as distributed application. A trace represents how a request, such as a user request, propagates through components of a distributed application or through services provided by each component of a distributed application. A trace consists of one or more spans, which are the separate segments of work represented in the trace. Each span represents an amount of time spent executing a service of the trace.

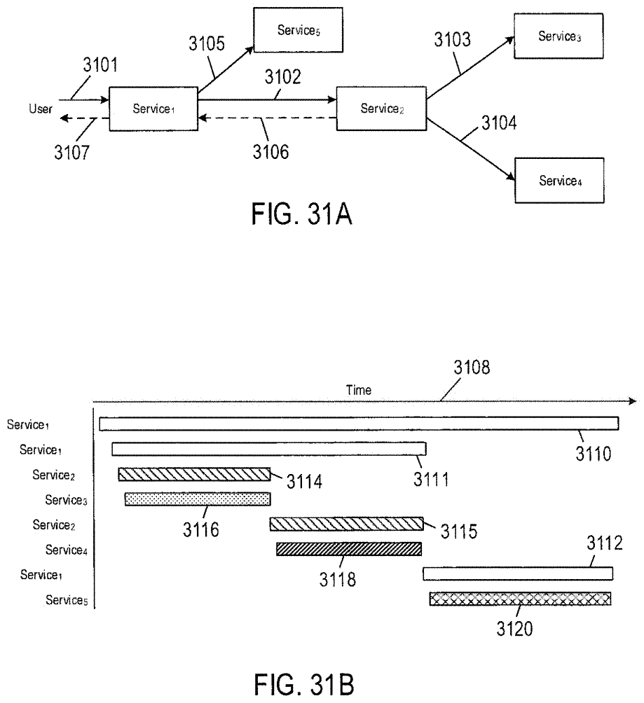

FIGS. 31A-31B show an example of constructing an application trace and spans. FIG. 31A shows an example of five services provided by a distributed application. The services are represented by blocks identified as Service₁, Service₂, Service₃, Service₄, and Service₅. The services may be web services provided to customers. For example, Service₁ may be a web server that enables a user to purchase items sold by the application owner. The services Service₂, Service₃, Service₄, and Service₅ are computational services that execute operations to complete the user's request. The services may be executed in a distributed application in which each component of the distributed application executes a service in a separate VM on different server computers or using shared resources of a resource pool provided by a cluster of server computers. Directional arrows 3101-3105 represent requests for a service provided by the services Service₁, Service₂, Service₃, Service₄, and Service₅. For example, directional arrow 3101 represents a user's request for a service, such as provided by a web site, offered by Service₁. After a request has been issued by the user, directional arrows 3103 and 3104 represent the Service₁ request for execution of services from Service₂ and Service₃. Dashed directional arrows 3106 and 3107 represent responses. For example, Service₂ sends a response to Service₁ indicating that the services provided by Service₃ and Service₄ have been executed. The Service₁ then requests services provided Service₅, as represented by directional arrow 3105, and provides a response to the user, as represented by directional arrow 3107.

FIG. 31B shows an example trace of the services represented in FIG. 31A. Directional arrow 3108 represents a time axis. Each bar represents a span, which is an amount of time spent executing a service. Unshaded bars 3110-3112 represent spans of time spent executing the Service₁. For example, bar 3110 represents the duration time Service₁ spends interacting with the user. Bar 3111 represents the duration of the time Service₁ spends interacting with the services provided by Service₂. Hash marked bars 3114-3115 represent spans of time spent executing Service₂ with services Service₃ and Service₄. Shaded bar 3116 represents a span time spent executing Service₃. Dark hash marked bar 3118 represents a span of time spent executing Service₄. Cross-hatched bar 3120 represents a span time spent executing Service₅.

The example trace in FIG. 31B is a trace that represents normal operation of the services represented in FIG. 31A. In other words, normal operations of the services represented in FIG. 31A are expected to produce a trace with spans of similar duration to the spans of the trace represented in FIG. 31B. Evidence of a performance problem with the objects that execute the services of a distributed application include erroneous traces (i.e., trace that fail to approximately match the trace in FIG. 31B) and traces with extended spans or latencies in executing a service.

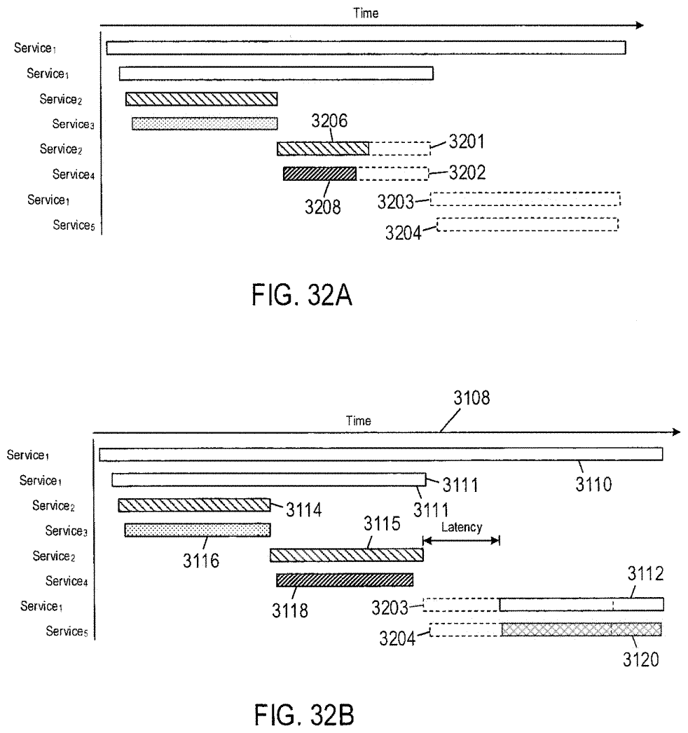

FIGS. 32A-32B shows two examples of erroneous traces associated with the services represented in FIG. 31A. In FIG. 32A, dashed line bars 3201-3204 represent normal spans for services provided by Service₁, Service₂, Service₄, and Service₅ as represented by spans 3115, 3118, 3112, and 3120 in FIG. 31B. Spans 3206 and 3208 represent shortened spans for Service₂ and Service₄. No spans are present for Service and Service₅ as indicated by dashed bars 3203 and 3204. In FIG. 32B, a latency pushes the spans 3112 and 3120 associated with executing corresponding Service₁ and Service₅ to later times.

Methods compute the frequency of traces that deviate from the trace in the troubleshooting time period as follows:

$${f}_{trαce} = \frac{n ( {trace}_{-} error )}{{N}_{t r a c e s}} \qquad ( 24 )$$

where
n(traces_error) is the number of traces that include errors or atypical durations with respect to a normal trace; and
N_{traces} is the total number of traces executing the troubleshooting time period.
   The entropy of erroneous traces that deviate from a normal trace in the troubleshooting time period is calculate by

H(f_{trace})=−log(f_{trace}) (25)

For each trace, a rank of traces that deviate from the normal trace is computed as follows:

$$Rank ( trace ) = \frac{1}{H ( {f}_{trace} )} \qquad ( 26 )$$

The trace rank, Rank(trace), may be used to indicate the importance of the trace.

Objects may be recommended based on the associated ranking. Highest ranked metrics, log messages, events, change properties, network flows, and traces may be itemized and displayed in a graphical user interface that also enables a user to rate the usefulness of the ranked items. User rates may be used to adjust the ranking metrics, log messages, events, change properties, network flows, and traces.

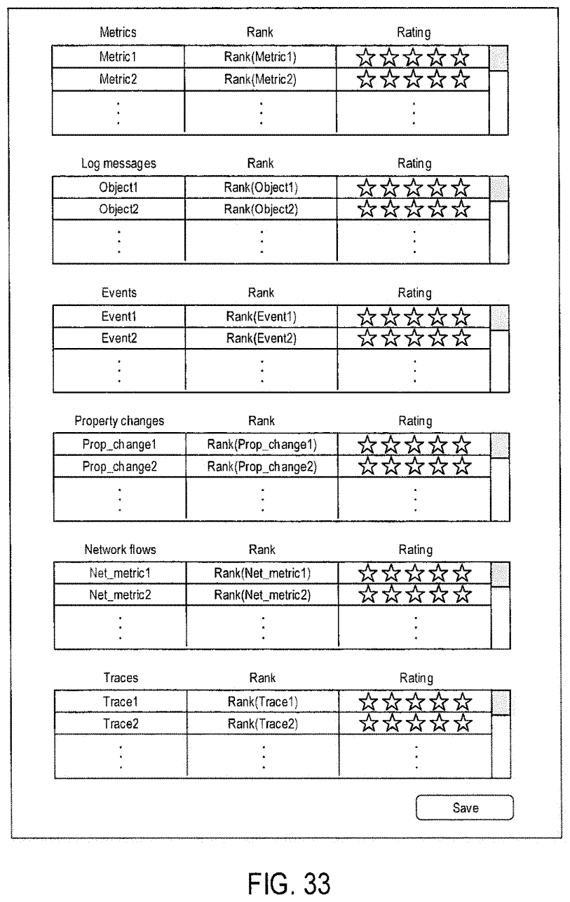

FIG. 33 shows an example of a graphical user interface that list the various types of evidence and enables a user to rate the evidence. The user may scroll through each type of evidence and select a star rating ranging from zero stars (i.e., not helpful) to five stars (i.e., very helpful) for the pieces of evidence the user found helpful in troubleshooting the performance problem. For example, evidence with a three-star user rating or higher may be identified as indicators of the performance problem. Based on the various types of evidence listed, a user may identify a performance problem associated with certain types of evidence and determine corresponding remedial measures for correcting the performance problem. The performance problems, associated types of evidence, and remedial measures may be stored so that when same evidence is presented in the future the remedial measures may be executed to correct the performance problems. Methods and systems may identify a performance problem based on associated types of evidence and generate recommended remedial measures for correcting a performance problem when the same types of evidence are detected, enabling users to quickly correct performance problems in the data center.

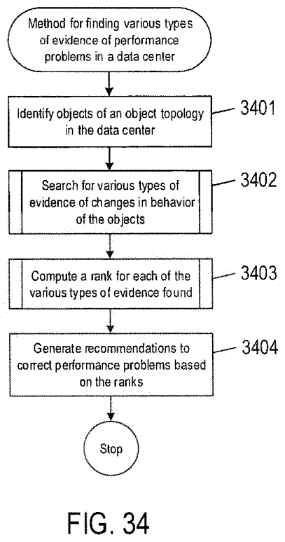

The methods described below with reference to FIGS. 34-40 are stored in one or more data-storage devices as machine-readable instructions that when executed by one or more processors of the computer system, such as the computer system shown in FIG. 1, troubleshoot anomalous behavior in a data center.

FIG. 34 is a flow diagram illustrating an example implementation of a “method for finding various types of evidence of performance problems in a data center.” In block 3301, objects comprising an object topology of the data center are identified. In block 3302, a “search for various types of evidence of changes in behavior of the objects” procedure is performed. In block 3403, a “compute a rank of each of the various types evidence found” procedure is performed. In block 3404, recommendations to correct the performance problems based on the ranks are generated.

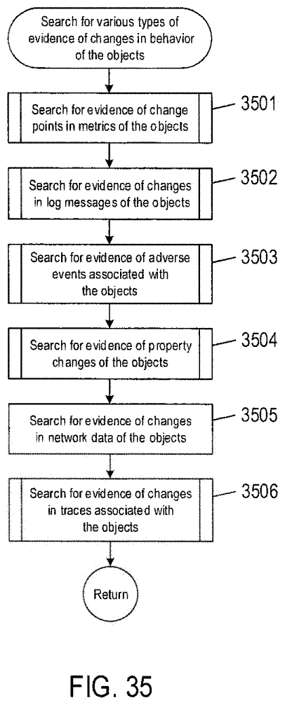

FIG. 35 is a flow diagram illustrating an example implementation of the “search for various types of evidence of changes in behavior of the objects” procedure performed in step 3402 of FIG. 34. In block 3501, a “search for evidence to change points in metrics of the objects” procedure is performed. In block 3502, a “search for evidence of changes in log messages of the objects” procedure is performed. In block 3503, a “search for evidence of adverse events associated with the objects” procedure is performed. In block 3504, a “search for evidence of property changes in the objects” procedure is performed. In block 3505, evidence of changes in network data of the objects is performed as described above with reference to Equation (23). In block 3506, a “search for evidence of changes in traces associated with the objects” procedure is performed.

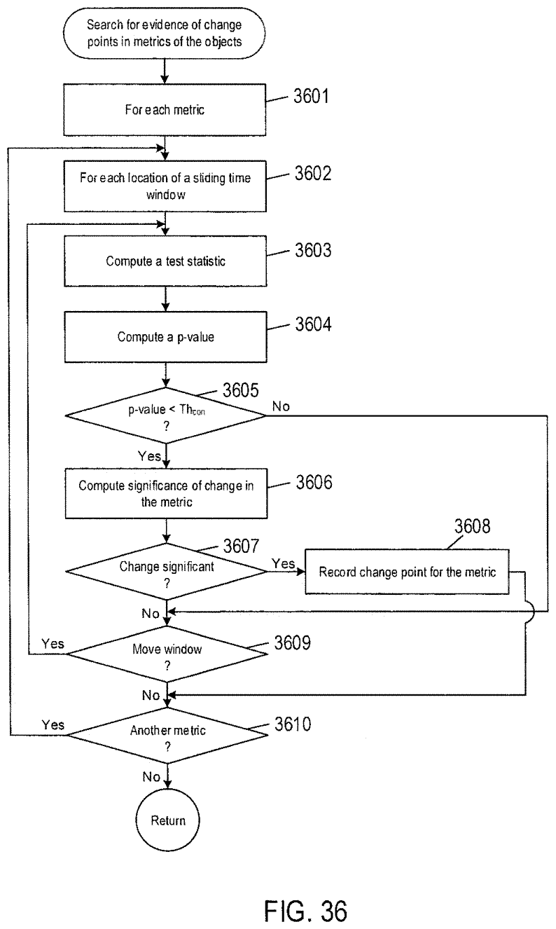

FIG. 36 is a flow diagram illustrating an example implementation of the “search for evidence to change points in metrics of the objects” procedure performed in step 3501 of FIG. 35. A loop beginning with block 3601 repeats the operations represented by blocks 3602-3609 for each metric of the object topology. A loop beginning with block 3602 repeats the operations represented by blocks 3603-3608 for each location of the sliding time window. In block 3603, a test statistic is computed as described above with reference to Equations (2) and (3). In block 3604, a p-value is computed as described above with reference to Equation (4). In decision block 3605, when the p-value is less than a confidence threshold, control flows to block 3506. In block 3606, a change magnitude is computed as described above with reference to Equation (6). In decision block 3607, when the change magnitude satisfied the condition in Equation (7) control flows to block 3508. In block 3608, the change point for the metric is recorded. In decision block 3609, blocks 3603-3808 are repeated for another location of the sliding time window. In decision block 3610, blocks 3602-3609 are repeated for another location of the sliding time window.

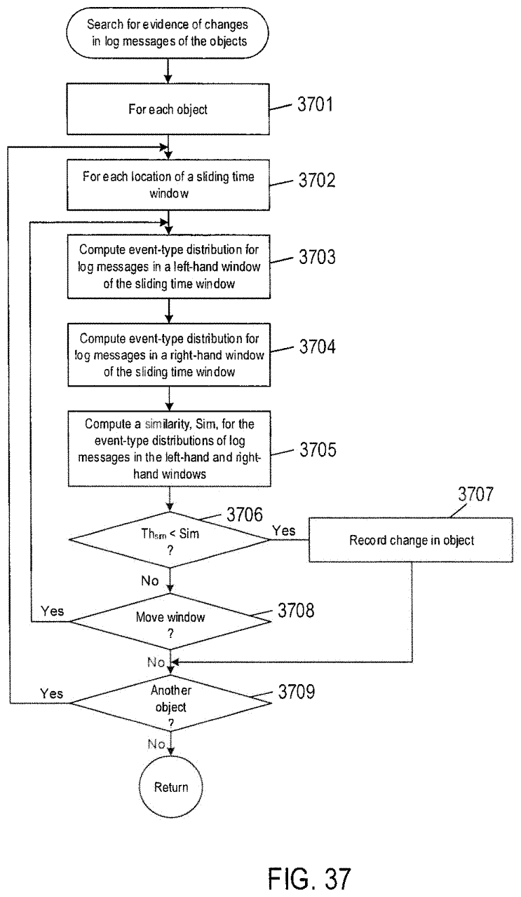

FIG. 37 is a flow diagram illustrating an example implementation of the “ ” procedure performed in step 3502 of FIG. 35. A loop beginning with block 3701 repeats the operations represented by blocks 3702-3708 for each object of the object topology. A loop beginning with block 3702 repeats the operations represented by blocks 3703-3707 for each location of a sliding time window in a troubleshooting time period. In block 3703, a first event-type distribution is computed for log messages in a left-hand window of the sliding time window. In block 3704, a second event-type distribution is computed for log messages in a right-hand window of the sliding time window. In block 3705, a similarity is computed for first event-type distribution and the second event-type distribution as described above with reference to Equations (12) and (13). In decision block 3605, when the similarity is greater than a similarity threshold control flows to block 3708. Otherwise control flows to block 3707 and the change in log messages is recorded. In decision block 3708, blocks 3702-3707 are repeated for another location of the sliding time window. In decision block 3709, blocks 3702-3707 are repeated for another object.

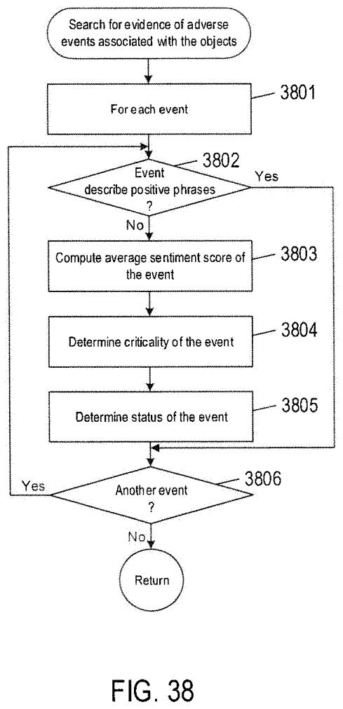

FIG. 38 is a flow diagram illustrating an example implementation of the “search for evidence of adverse events associated with the objects” procedure performed in step 3503 of FIG. 35. A loop beginning with block 3801 repeats the operations represented by blocks 3802-3805 for each event associated with objects of the object topology. In decision block 3802, control flows to block 3803 for an event that does not contain positive phrases. In block 3803, an average sentiment score is computed as described above with reference to FIG. 29. In block 3804, a criticality is computed for the event as described above with reference to FIG. 29. In block 3805, status of the event is determined as describe above with reference to Equation (18). In decision block 3806, blocks 3802-3805 are repeated for another event.

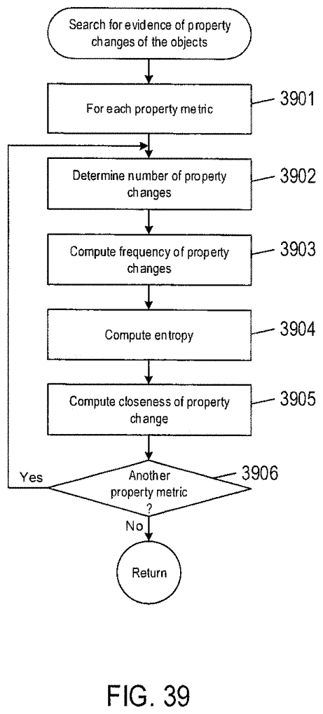

FIG. 39 is a flow diagram illustrating an example implementation of the “search for evidence of property changes of the objects” procedure performed in step 3504 of FIG. 35. A loop beginning with block 3901 repeats the operations represented by blocks 3902-3905 for each property metric associated with objects of the object topology. In block 3902, the number of property change associated with the metric is determined. In block 3903, a frequency of property changes is computed as described above with reference to Equation (20). In block 3904, entropy is computed as described above with reference to Equation (21). In block 3905, closeness of the property change to the performance problem time is computed as described above. In decision block 3906, blocks 3902-3906 are repeated for another property metric.

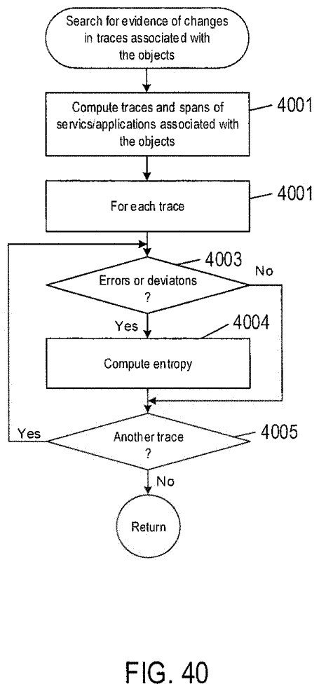

FIG. 40 is a flow diagram illustrating an example implementation of the “search for evidence of changes in traces associated with the objects” procedure performed in step 3506 of FIG. 35. In block 4001, traces and spans are determined for applications and services executing in the object topology. A loop beginning with block 4002 repeats the operations represented by blocks 4003-4004. In decision block 4003, when errors and deviations in the trace differ from a normal trace for the operations is detected, control flows to block 4004. In block 4004, entropy is computed for the trace is computed as described above with reference to Equation (25). In decision block 4005, blocks 4003 and 4004 are repeated for another trace.

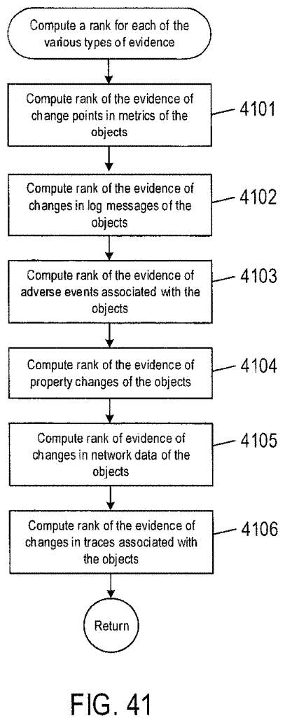

FIG. 41 is a flow diagram illustrating an example implementation of the “compute a rank for each of the various types of evidence” procedure performed in block 3403 of FIG. 34. In block 4101, a rank of the evidence of change points in the metrics is computed as described above with reference to Equation (8). In block 4102, a rank of the evidence of changes in log messages of the objects is computed as described above with reference to Equation (15). In block 4103, a rank of the evidence of adverse events associated with the objects is computed as described above with reference to Equation (18). In block 4104, a rank of the evidence of property changes of the objects is computed as described above with reference to Equation (22). In block 4105, a rank of the evidence of changes to network metrics is computed as described above with reference to Equation (23). In block 4106, a rank of the evidence of changes in traces associated with the objects is computed as described above with reference to Equation (26).

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method stored in one or more data-storage devices and executed using one or more processors of a computer system for finding various types of evidence of performance problems in a data center, the method comprising:
identifying objects of an object topology of the data center;
searching for various types of evidence of changes in behavior of the objects with a troubleshooting time period;
computing a rank for each of the various types of evidence of changes found in the search; and
generating a recommendation that corrects performance problems associated with the changes in behavior based the rank of each of the various types of evidence.

2. The method of claim 1 wherein searching for various types of evidence of changes in behavior of the objects comprises searching for evidence of change points in metrics of the objects within the troubleshooting time period.

3. The method of claim 1 wherein searching for various types of evidence of changes in behavior of the objects comprises searching for evidence of changes in log messages associated with the objects, the log messages generated within the troubleshooting time period.

4. The method of claim 1 wherein searching for various types of evidence of changes in behavior of the objects comprises searching for evidence of adverse events associated with the objects within the troubleshooting time period.

5. The method of claim 1 wherein searching for various types of evidence of changes in behavior of the objects comprises searching for evidence of property changes in the objects.

6. The method of claim 1 wherein searching for various types of evidence of changes in behavior of the objects comprises searching for evidence of changes in network data of the objects.

7. The method of claim 1 wherein searching for various types of evidence of changes in behavior of the objects comprises searching for evidence of changes in application traces associated with the objects.

8. The method of claim 1 further comprises providing a graphical user interface that enables a user to rate each of the various types of evidence.

9. A computer system for finding various types of evidence of performance problems in a data center, the system comprising:
one or more processors;
one or more data-storage devices; and
machine-readable instructions stored in the one or more data-storage devices that when executed using the one or more processors controls the system to perform the operations comprising:
identifying objects of an object topology of the data center;
searching for various types of evidence of changes in behavior of the objects with a troubleshooting time period;
computing a rank for each of the various types of evidence of changes found in the search; and
generating a recommendation that corrects performance problems associated with the changes in behavior based the rank of each of the various types of evidence.

10. The system of claim 9 wherein searching for various types of evidence of changes in behavior of the objects comprises searching for evidence of change points in metrics of the objects within the troubleshooting time period.

11. The system of claim 9 wherein searching for various types of evidence of changes in behavior of the objects comprises searching for evidence of changes in log messages associated with the objects, the log messages generated within the troubleshooting time period.

12. The system of claim 9 wherein searching for various types of evidence of changes in behavior of the objects comprises searching for evidence of adverse events associated with the objects within the troubleshooting time period.

13. The system of claim 9 wherein searching for various types of evidence of changes in behavior of the objects comprises searching for evidence of property changes in the objects.

14. The system of claim 9 wherein searching for various types of evidence of changes in behavior of the objects comprises searching for evidence of changes in network data of the objects.

15. The system of claim 9 wherein searching for various types of evidence of changes in behavior of the objects comprises searching for evidence of changes in application traces associated with the objects.

16. The system of claim 9 further comprises providing a graphical user interface that enables a user to rate each of the various types of evidence.

17. A non-transitory computer-readable medium encoded with machine-readable instructions that implement a method carried out by one or more processors of a computer system to perform the operations comprising:
identifying objects of an object topology of the data center;
searching for various types of evidence of changes in behavior of the objects with a troubleshooting time period;
computing a rank for each of the various types of evidence of changes found in the search; and
generating a recommendation that corrects performance problems associated with the changes in behavior based the rank of each of the various types of evidence.

18. The medium of claim 17 wherein searching for various types of evidence of changes in behavior of the objects comprises searching for evidence of change points in metrics of the objects within the troubleshooting time period.

19. The medium of claim 17 wherein searching for various types of evidence of changes in behavior of the objects comprises searching for evidence of changes in log messages associated with the objects, the log messages generated within the troubleshooting time period.

20. The medium of claim 17 wherein searching for various types of evidence of changes in behavior of the objects comprises searching for evidence of adverse events associated with the objects within the troubleshooting time period.

21. The medium of claim 17 wherein searching for various types of evidence of changes in behavior of the objects comprises searching for evidence of property changes in the objects.

22. The medium of claim 17 wherein searching for various types of evidence of changes in behavior of the objects comprises searching for evidence of changes in network data of the objects.

23. The medium of claim 17 wherein searching for various types of evidence of changes in behavior of the objects comprises searching for evidence of changes in application traces associated with the objects.

24. The medium of claim 17 further comprises providing a graphical user interface that enables a user to rate each of the various types of evidence.
